(19) United States
(12) Patent Application Publication
(10) Pub. No.: US 2025/0300560 A1
(43) Pub. Date: Sep. 25, 2025

(54) MULTIPHASE POWER CONVERTER WITH DISTRIBUTED CONTROL

(71) Applicant: TEXAS INSTRUMENTS INCORPORATED, Dallas, TX (US)

(72) Inventors: Sombuddha Chakraborty, Redwood City, CA (US); Kevin Scoones, San Jose, CA (US); Taisuke Kazama, Plano, TX (US)

(21) Appl. No.: 19/080,736

(22) Filed: Mar. 14, 2025

Related U.S. Application Data
(60) Provisional application No. 63/567,709, filed on Mar. 20, 2024.

(51) Int. Cl. H02M 3/158; H02M 1/00

(52) U.S. Cl. CPC H02M 3/158; H02M 1/0009

(57) ABSTRACT

An apparatus includes an integrated circuit comprising a power stage having a control input and a voltage output terminal, and a controller that has a feedback voltage input, an error signal input, and a control output. The control output is coupled to the control input of the power stage. The controller is configurable to provide a modulated signal at the control output responsive to a first signal at the feedback voltage input and a second signal at the error signal input. The second signal includes an integral of a difference between the first signal and a reference signal. In some examples, the second signal is generated by an integral controller and is used by multiple integrated circuits to control multiple power stages in a multiphase power converter.

### CROSS-REFERENCE TO RELATED APPLICATION

This application claims the benefit of and priority to U.S. Provisional Application No. 63/567,709, filed Mar. 20, 2024, entitled “Multiphase Power Converter with Distributed Control,” which is assigned to the assignee hereof and is hereby incorporated by reference in its entirety for all purposes.

### BACKGROUND

In electronic systems, power management devices such as voltage regulators or power converters may be used to generate appropriate voltage levels to drive other devices such as central processing units (CPUs), graphic processing units (GPUs), field-programmable gate arrays (FPGAs), application-specific integrated circuits (ASICs), system-in-chips (SOCs), memory, and other circuits that may consume power during operations. To achieve the target speed, signal quality, and other performance of the system, it is desirable that the power system (including power management devices and power distribution networks) for delivering power to the power-consuming devices can have a low impedance across a wide frequency range and have a low delay (and fast response) in response to load transient events, such as sudden changes to the load current of the system. In addition, it is desirable that the power system can have a high efficiency, a low cost, and a small footprint.

### SUMMARY

This summary is provided to introduce examples of disclosed concepts in a simplified form, which are further described below in the Detailed Description including the drawings provided.

According to certain aspects, an apparatus may include an integrated circuit comprising a power stage having a control input and a voltage output terminal, and a controller. The controller may have a feedback voltage input, an error signal input, and a control output, the control output coupled to the control input of the power stage, the controller configurable to provide a modulated signal at the control output responsive to a first signal at the feedback voltage input and a second signal at the error signal input.

According to certain aspects, an apparatus may include a first integrated circuit, a second integrated circuit, and a third integrated circuit. The first integrated circuit may have a first feedback voltage input and an error signal output, the first feedback voltage input coupled to a power rail. The second integrated circuit may have a second feedback voltage input, a first error signal input, and a first power output, the second feedback voltage input coupled to the power rail, the first error signal input coupled to the error signal output, and the first power output coupled to the power rail. The third integrated circuit may have a third feedback voltage input, a second error signal input, and a second power output, the third feedback voltage input coupled to the power rail, the second error signal input coupled to the error signal output, and the second power output coupled to the power rail.

According to certain aspects, an apparatus may include an integral controller having a first feedback voltage input, a reference voltage input, and a first control output; a first proportional controller having a second feedback voltage input, a first control input, and a second control output, the first control input coupled to the first control output; a second proportional controller having a third feedback voltage input, a second control input, and a third control output, the second control input coupled to the first control output; a first power stage having a first power input, a first power stage control input, and a first power output, the first power stage control input coupled to the second control output; and a second power stage having a second power input, a second power stage control input, and a second power output, the second power stage control input coupled to the third control output.

The foregoing summary outlines rather broadly various features of examples of the present disclosure so that the following detailed description may be better understood. Additional features and advantages of such examples will be described hereinafter. This summary is neither intended to identify key or essential features of the claimed subject matters, nor is it intended to be used in isolation to determine the scope of the claimed subject matters. The subject matters should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative examples are described in detail below with reference to the following figures.

FIG. 1 is a schematic of an example of an electrical system.

FIG. 2 is a schematic of an example of a voltage-mode power converter.

FIG. 3 is a schematic of an example of a constant-on-time (COT) power converter.

FIG. 4A is a diagram illustrating an example of operations of a voltage mode (or current mode) power converter in response to a load current step-up.

FIG. 4B is a diagram illustrating an example of operations of a COT power converter in response to a load current step-up.

FIG. 5A is a schematic of power phases of an example of a multiphase power converter.

FIG. 5B illustrates examples of control signals for controlling the power phases of the multiphase power converter of FIG. 5A.

FIG. 6 is a schematic of an example of a centralized COT (CCOT) multiphase power converter.

FIG. 7A is a block diagram of an example of a system that includes a power converter.

FIG. 7B illustrates an example of impedance profiles of components of a power distribution network of the system of FIG. 7A.

FIG. 7C illustrates an example of an frequency response of a power converter.

FIG. 8A is a block diagram of an example of a distributed COT (DCOT) multiphase power converter.

FIG. 8B illustrates control loops of the example of the DCOT multiphase power converter of FIG. 8A.

FIG. 9 is a schematic of an example of a DCOT multiphase power converter.

FIG. 10 is a schematic of another example of a DCOT multiphase power converter.

FIG. 11A is block diagram of an example of a system including a CCOT multiphase power converter.

FIG. 11B is block diagram of an example of a system including a DCOT multiphase power converter.

The drawings and accompanying detailed description are provided for understanding of features of various examples and do not limit the scope of the appended claims. The examples illustrated in the drawings and described in the accompanying detailed description may be readily utilized as a basis for modifying or designing other examples that are within the scope of the appended claims. One skilled in the art will readily recognize from the following description that alternative examples of the structures and methods illustrated may be employed without departing from the principles, or benefits touted, of this disclosure. Identical reference numerals may be used, where possible, to designate identical elements that are common among drawings. The figures are drawn to clearly illustrate the relevant elements or features and are not necessarily drawn to scale.

### DETAILED DESCRIPTION

The present disclosure relates generally to power management systems and devices. More specifically, techniques disclosed herein relate to multiphase power converter that include distributed control circuits for power stages. According to some examples, a multiphase power converter may include a central controller and a plurality of local controller configurable to control a plurality of power stages. The central controller may include at least an integral controller configurable to generate an integral error signal that may be an integral of a difference between a reference voltage and a feedback voltage that is proportional (or equal) to the output voltage of the multiphase power converter. Each local controller may be close to a corresponding power stage, and may generate control signals (e.g., pulse width modulation signals) for the corresponding power stage based on the integral error signal from the central controller, a feedback voltage, a ramp signal, a current of the corresponding power stage, a reference clock signal, an address of the power stage or local controller, or a combination thereof.

An electronic system may include one or more high-speed, high-performance digital devices and other devices, such as memory devices, sensing devices, and analog devices, on one or more substrates, such as printed circuit boards (PCBs). The high-speed, high-performance digital devices, such as microprocessors, graphic processing units, digital signal processors, neural processing units, tensor processing units, application-specific integrated circuits (ASICs), and field-programmable gate arrays (FPGAs), may have increased speed, increased processing power, increased power consumption, and/or decreased power supply voltage (e.g., lower than IV), compared with devices in the past, due to the smaller feature sizes achieved by the rapid development in semiconductor manufacturing technology. Other devices manufactured using different processing technologies and/or different semiconductor material systems may also use different supply voltage levels. Therefore, the electronic system may include power management devices to provide different voltage levels (e.g., 5V, 3.3 V, 1.8V, 1.2 V, 0.9V, etc.) to drive the different devices. To enable high speed and high performance, the power management devices may include voltage regulators, such as direct current to direct current (DC-DC) power converters with low output voltage, low output ripple, high power, fast transient response, and high efficiency, to supply different supply voltages to the digital devices.

One example of the DC-DC power converters is a buck converter, which is a switch-mode step-down converter that can convert a direct current (DC) voltage to a lower DC voltage, and can provide high efficiency and flexibility for a wide range of input/output voltage ratio and load current. A buck converter may include a high-side switch (e.g., a metal-oxide-semiconductor field-effect transistor (MOSFET) switch) and a low-side synchronous rectifier switch (e.g., a MOSFET) that are switched on and off by a control circuit to regulate the average output voltage. The switching voltage waveform outputted by the switches may be filtered by an inductor-capacitor (LC) filter stage to drive a load. The control circuit may include a duty-cycle control circuit that uses a feedback loop to sense the output voltage and control the duty cycle of the high-side switch, thereby regulating the output voltage. Because the high-side switch and the low-side switch are either turned on or off, they may dissipate little power. The duty cycle control enables a wide range of input/out voltage ratios, and thus a buck converter can covert a DC voltage to a wide range of lower DC voltage levels.

DC-DC power converters such as buck converters may use various modulation schemes to regulate the output voltage, such as voltage mode, current mode, hysteretic mode, constant on-time (COT) mode, constant off-time mode, and adaptive on-time mode control schemes. Both voltage mode and current mode control schemes may use loop compensation circuitry to achieve stable operations in a wide input voltage range. The loop compensation circuitry may have a finite loop bandwidth (e.g., limited by the switching frequency and/or loop delay), and thus may be difficult to achieve fast transient response. COT mode power converters may have a relatively simple architecture and fast load transient response, and thus may be suitable for use in some high-speed, high-performance electronic systems.

In some complex systems, multiphase power converters may be used to meet the high power demands. One example of a multiphase power converter is a multiphase buck converter. A multiphase buck converter may include a set of power phases, each with its own inductor and a set of transistors (e.g., in a half bridge configuration) that collectively form a power phase. The set of power phases may be connected in parallel and share both the input and output capacitors. During steady-state operations, individual power phases may be active at interleaved intervals equal to about 360°/N throughout the switching period, where N is the total number of power phases. Compared with a single-phase power converter, a multiphase power converter can provide high output currents, improved thermal performance and efficiency at high load currents, and reduced undershoot and overshoot during load transients, and may have reduced requirements for input and/or output capacitances to achieve a certain output ripple performance.

Similar to a single-phase power converter, a multiphase power converter may include a control loop that regulates the power and voltage level provided to the load. The control loop may be implemented using, for example, a proportional-integral-derivative (PID) controller that may include at least one of a proportional controller (Kp), an integral controller (Ki), or a derivative controller (Kd). The integral controller (Ki) may include a relatively low-bandwidth control loop that may correct DC or low-frequency errors. The proportional controller (Kp) may include an alternating current (AC) control loop that has a relatively high bandwidth, and may correct transient (AC) errors. The delay in the control loop of the power converter may set a pole in the frequency response transfer function of the power converter. The pole may limit the bandwidth that can be achieved by the power converter with sufficient phase margin and stability. Therefore, it is advantageous to reduce the delay of the control loop of the multiphase power converter.

It is also beneficial that a power converter has a low output impedance within a wide frequency range (e.g., from DC to a high frequency such as tens of megahertz or higher), which may reduce the overall output impedance of the power distribution network (PDN), reduce the changes in the output voltage due to load current transients, and reduce the number and/or capacitance values of decoupling capacitors that otherwise would be used to achieve a low output impedance and a low voltage drop in the power distribution network. For example, one way to reduce the output impedance of the PDN is using capacitors of various sizes at the outputs of the power converters and/or near the power consuming devices. The capacitors can include large capacitors that can provide low impedance at low frequencies, and smaller capacitors that can provide low impedance at high frequencies. By reducing the AC loop delay thereby extending the bandwidth of the power converter, the output impedance of the power converter can be low from DC to higher frequencies, and thus at least some large capacitors used to provide low impedance at low frequencies can be eliminated from the electronic system, which may reduce the size and cost of the electronic system.

Some multiphase power converters may use a centralized proportional-integral-derivative (PID) controller to control the switching (e.g., the duty cycle and/or switching frequency) of the power stages in the multiple power phases by correcting the AC and DC errors. But such centralized controller may not be able to achieve a high bandwidth at least due to the long delay of the control loop. For example, a large buffer may be used at the output of the centralized controller to provide PWM signals with fast rising and falling edges to drive the power stages of the multiple power phases, which may be connected in parallel and spatially distributed on a PCB through long interconnects that may add a large capacitive loading to the output of the buffer). The large buffer and the long interconnects at the output of the centralized controller may introduce a large delay to the control loop, and thus may limit the bandwidth of the control loop. In addition, since a centralized controller is used to generate the switching control signals for all power phases (e.g., N power phases), the centralized controller would operate at a clock frequency that is N times of the switching frequency of each power stage. Therefore, the centralized controller may not be able to support a large number of power phases and thus a high load current at least due to the operating frequency limitation. Furthermore, routing the control signals (e.g., PWM signals) from the centralized controller to the individual power phases and routing the feedback signals (e.g., the sensed output voltage and/or the sensed current signal of each power phase) from the individual power phases to the centralized controller may lead to board routing and layout challenge as the number of power phases increases.

According to some examples, a multiphase power converter may include a central controller and a set of local controllers to implement a distributed control scheme. The central controller is configurable to generate a low bandwidth signal to be shared among multiple power phases, and may also include a plurality of local controllers located close to corresponding power stages to form local feedback loops that may have much lower delay, much higher bandwidths, and much faster transient response. In one example, the central controller may include an integral controller (Ki) to generate a DC or low-frequency loop control signal that may be an integral of a difference (error) between a reference voltage and the sensed output voltage of the power converter. In some examples, the central controller may include an optional proportional controller. In some examples, the central controller may include a PID controller. The power phases may share the same DC or low-frequency loop control signal generated by the central controller.

Each local controller may include a proportional controller (Kp) implemented locally at each power phase to provide a local AC feedback loop to reduce the loop delay and improve the loop bandwidth, thereby improving the transient response of the power converter. Each local AC feedback loop or local controller may include, for example, a proportional controller (e.g., a proportional amplifier), a comparator, an on-time modulation and phase shift stage, and a gate driver. Each local AC loop can sense the output voltage locally (at the power stage) or at the load. The proportional controller may generate an output error signal that may be proportional to the error of the output voltage (e.g., with respect to a reference voltage). The comparator may compare the output error signal with a ramp signal to generate a pulse signal that includes pulses for switching the switches in the power stage of each power phase. The on-time modulation and phase shift stage may modulate the on-time (e.g., pulse width or pulse density) of the pulses, and may also modulate the phase of the pulses with respect to the phases of the modulated pulse signals for other power stages based on a common reference clock from the central controller, to achieve good transient and DC performance. The gate driver may drive the modulated pulse signal to control the switches (e.g., MOSFETs) of the power stage. In some examples, the local controller may also include a circuit that may sense the current of the power stage, compare the current with an average current of the power stages of the multiple power phases, and generate an input signal for the comparator, thereby modulating the pulse signal to balance the current load between the power phases.

With such arrangements, the multiphase power converter architecture may have a reduced loop delay or latency (and an improved bandwidth), which allows for increased switching frequency (e.g., short on time or short off time) and superior transient and high-frequency operation performance. Due to the shorter control loop delay, the output impedance of the multiphase power converter can remain low from DC to a higher frequency, and thus the capacitance values and/or the number of capacitors at the output of the power converter can be reduced, which can reduce the overall sizes/footprints of the power converter and the electronic system including the power converter. In addition, in the multiphase power converters disclosed herein, the comparator in each local controller generates switching control signals for the power stage of one power phase, and thus the comparator can operate at the switching frequency of the power stage, regardless of the number of power phases in the multiphase power converters. Therefore, the number of power phases in the multiphase power converter may not be limited by the operating frequency and can be increased to support a high load current. Furthermore, in the multiphase power converters disclosed herein, the same DC or low-frequency loop control signal, clock signal, and/or average current signal are shared by all power phases and thus can be more easily routed from the central controller to the local controllers of all power phases. Therefore, the number of pins on the central controller and the routing overhead on a PCB can be significantly reduced, in particular, when the number of power phases is large. Therefore, the multiphase power converters disclosed herein can have more power phases to support a higher load current with low routing overhead and a relative low clock frequency.

Various features are described hereinafter with reference to the figures. An illustrated example may not have all the aspects or advantages shown. An aspect or an advantage described in conjunction with a particular example is not necessarily limited to that example and can be practiced in any other examples even if not so illustrated or if not so explicitly described. Further, methods described herein may be described in a particular order of operations, but other methods according to other examples may be implemented in various other orders (e.g., including different serial or parallel performance of various operations) with more or fewer operations.

Various examples are described herein. Although the specific examples may illustrate various aspects of the above generally described features, examples may incorporate any combination of the above generally described features (which are described in more detail in examples below). Three dimensional x-y-z axes are illustrated in some figures for case of reference. Some cross-sectional views of various semiconductor devices herein may be general depictions to illustrate various aspects or concepts concerning such semiconductor devices. More specifically, some drain contact structures illustrated in cross-sectional views may not necessarily accurately depict a structure of such drain contact contacts, except to the extent described herein. The illustrations of those drain contact structures are to illustrate various aspects or concepts concerning those drain contact structures.

In the following description, for the purposes of explanation, specific details are set forth in order to provide a thorough understanding of examples of the disclosure. However, it will be apparent that various examples may be practiced without these specific details. For example, devices, systems, structures, assemblies, integrated circuits, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any example or design described herein as “example” is not necessarily to be construed as preferred or advantageous over other examples or designs.

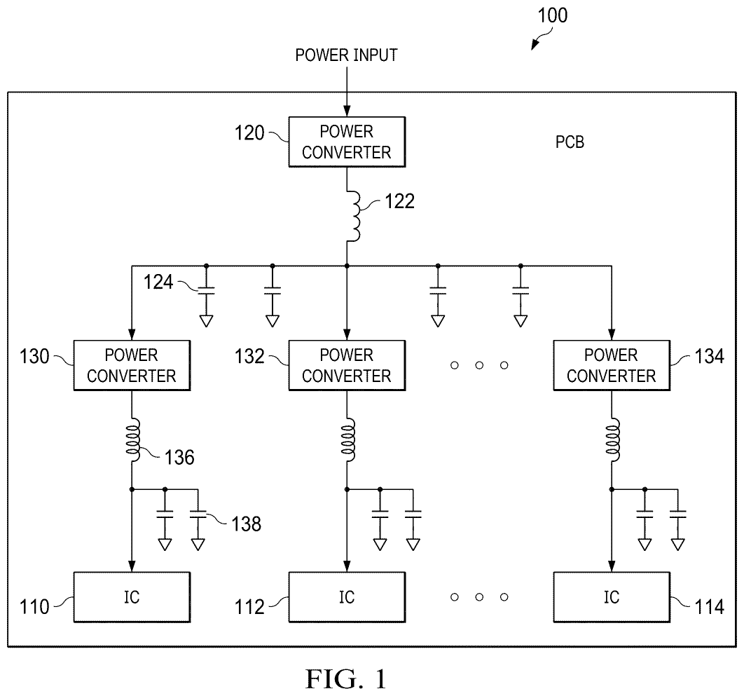

FIG. 1 is a schematic of an example of an electrical system that may include multiple components mounted on and connected together via a PCB 100. The components may include one or more integrated circuits (e.g., integrated circuits 110, 112, . . . , and 114). The one or more integrated circuits may include, for example, one or more central processing units (CPUs), graphic processing units (GPUs), neural processing units (NPUs), tensor processing units (TPUs), digital signal processors (DSPs), field-programmable gate arrays (FPGAs), application-specific integrated circuits (ASICs), system-in-chips (SOCs), memory chips, and the like. The one or more integrated circuits may be fabricated using different semiconductor processing techniques and may have different operating voltage levels, such as 5 V, 3.3 V, 1.8 V, 1.2 V, or 0.9 V. One or more voltage regulators or power converters may be used to provide the different voltage levels based on a power input.

In the illustrated example, the one or more power converters may include a power converter 120 (e.g., DC-DC converter), which may, for example, convert the higher voltage of the power input to a lower voltage, such as 3-5 V. The power input may be, for example, greater than about 10 V, such as 12V or higher. An LC filter that includes an inductor 122 and one or more capacitors 124 may be mounted on PCB 100 to filter the output of power converter 120, such that the output voltage level may be relatively stable with low ripples. In one example, power converter 120 may be at an edge of PCB 100. The one or more capacitors 124 may include capacitors of different values and sizes, and may be distributed on PCB 100 (e.g., on both sides of PCB 100). Some capacitors 124 may be close to power converter 120, while some other capacitors 124 may be away from power converter 120 and close to the one or more integrated circuits.

The one or more power converters on PCB 100 may also include one or more power converters 130, 132, . . . , and 134 (e.g., DC-DC converters) that may be closer to the one or more integrated circuits 110, 112, . . . , and 114. Power converters 130, 132, . . . , and 134 may convert the output voltage from power converter 120 to lower voltage levels that may be used by integrated circuits 110, 112, . . . , and 114, such as below 3 V (e.g., 1.8 V, 1.2 V, 1 V, or lower). The output of each of power converters 130, 132, . . . , and 134 may be filtered by an LC filter that may include an inductor 136 and one or more capacitors 138, such that the output voltage level may have low ripples. In some examples, power converters 130, 132, . . . , and 134 may be on a side of PCB 100 opposing the side where integrated circuits 110, 112, . . . , and 114 are mounted, such as directly underneath a corresponding integrated circuit 110, 112, or 114. Capacitors 138 may also be mounted on one side or both sides of PCB 100.

In some examples, PCB 100 may include some decoupling capacitors on one side or both sides of PCB 100. In some examples, one or more decoupling capacitors may be mounted on the package of an integrated circuit 110, 112, or 114. In some examples, an integrated circuit may include on-chip capacitors formed on the semiconductor die, or capacitors formed in the package. PCB 100 may include one or more power and ground layers for distributing power from the power input to integrated circuits 110, 112, . . . , and 114. The power converters, inductors, capacitors of different values, sizes, and distances from the one or more integrated circuits, and the power and ground layers described above may together form a power distribution (or delivery) network (PDN). To support high frequency and high signal integrity operations of PCB 100, the PDN may have a high bandwidth and a low delay such that the PDN may respond to sudden changes in the load current quickly to avoid a large drop in the output voltage. The PDN may also have low impedance across the operating frequency of the PCB 100, such that the voltage drop in the PDN due to high current can be reduced to avoid ground bounce and power rail collapse, which may change the supply voltage level at the integrated circuits and thus the performance and signal integrity of the integrated circuits.

One example of the DC-DC power converters described with respect to FIG. 1 is a buck converter. A buck converter is a switch-mode step-down converter that converts a DC voltage to a lower DC voltage. A buck converter may include a high-side switch (e.g., a MOSFET) and a low-side synchronous rectifier switch (e.g., a MOSFET) that are switched on and off by a control circuit to regulate the average output voltage for driving a load. The switching voltage waveform outputted by the switches may be filtered by an LC filter to reduce ripples at the load. The control circuit may use a feedback loop to sense the output voltage, generate an error signal based on the difference between the sensed output voltage and the target voltage, and control the switching (e.g., the duty cycle and/or switching frequency) of the switches based on the error signal, thereby regulating the output voltage. Various control techniques, such as the voltage mode, current mode, hysteretic mode, constant on-time mode, constant off-time mode, and adaptive on-time mode control schemes, may be used in buck converters to achieve a stable output voltage for a wide input voltage range.

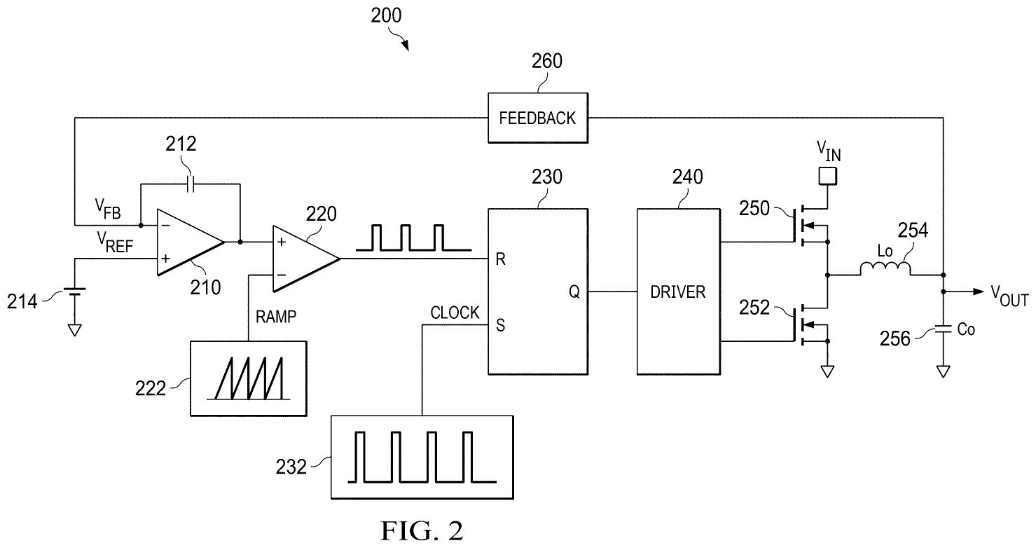

FIG. 2 is a schematic of an example of a power converter 200. Power converter 200 may be a voltage mode or current mode buck converter. In the illustrated example, power converter 200 may include an error amplifier 210, a PWM comparator 220, a latch 230, a driver 240, a power stage, and a feedback circuit 260, which may be on a same semiconductor die in some examples. An LC filter may be used at the output of power stage to stabilize an output voltage V_{OUT} for driving a load, such as an integrated circuit 110, 112, or 114. The LC filter may include an inductor 254 and one or more capacitors 256. In some examples, inductor 254 and capacitor(s) 256 may be discrete components mounted on a PCB.

The power stage may include a high-side switch 250 (e.g., a MOSFET) and a low-side switch 252 (e.g., a MOSFET). High-side switch 250 may be coupled between a power source that provides an input voltage VIN (not shown in the figure) and inductor 254, and may be switched by a control voltage at a gate of the MOSFET. Low-side switch 252 may be coupled between inductor 254 and a ground, and may be switched by a control voltage at a gate of the MOSFET. When high-side switch 250 is switched on, current may flow from input voltage VIN, through high-side switch 250, to inductor 254, one or more capacitors 256, and the load. Low-side switch 252 may function as a synchronous rectifier that provides a controlled path for current to return to the source when the high-side switch is turned off, thereby improving the efficiency of the power converter by minimizing energy losses. In a buck converter, high-side switch 250 and low-side switch 252 may be turned on and off in a cyclic and complementary manner.

The output voltage V_{OUT} may be proportional to the input voltage VIN and the duty cycle of the on-time of high-side switch 250 during steady-state operations. Therefore, the output voltage level can be regulated by adjusting the duty cycle of the on-time of high-side switch 250 based on the difference between a target output voltage level and the actual output voltage level at the load. The duty cycle control enables a wide range of input/out voltage ratios and thus can covert a DC voltage to a wide range of lower DC voltage levels. The control signal for controlling the switching of high-side switch 250 and low-side switch 252 may be generated by the loop that includes error amplifier 210, PWM comparator 220, latch 230, driver 240, the power stage, and feedback circuit 260. Because high-side switch 250 and low-side switch 252 are either turned on or off, they may dissipate little power.

Error amplifier 210 may include a first input coupled to feedback circuit 260, a second input coupled to a reference voltage source 214, and a negative feedback circuit that may be coupled to the first input and the output of error amplifier 210. Feedback circuit 260 may include, for example, a voltage divider that may divide the output voltage (VOLT) at the load to generate a scaled down feedback voltage (V_{FB}) that may be a fraction of the output voltage at the load. The negative feedback circuit may include at least a capacitor 212 (or a capacitor and a serial resistor), such that error amplifier 210 may function as an integrator (and a low-pass filter) that may integrate the difference (error) between the feedback voltage (V_{FB}) and a reference voltage (V_{REF}) generated by reference voltage source 214, to amplify and filter the error and generate an error signal at the output of error amplifier 210.

PWM comparator 220 may include a first input coupled to the output of error amplifier 210, a second input coupled to a ramp generator 222, and an output coupled to latch 230. Ramp generator 222 may generate a sawtooth ramp signal. In some examples, ramp generator 222 may generate the sawtooth ramp signal based on a clock signal, and the power converter 200 may be a voltage mode buck converter. In some examples, ramp generator 222 may generate the sawtooth ramp signal based on a sensed current (which may have a sawtooth shape) at the power stage or load (e.g., inductor 254) of power converter 200, and thus power converter 200 may be a current mode buck converter. PWM comparator 220 may compare the voltage levels of the error signal and the ramp signal, and generate a pulse signal at the output of PWM comparator 220. For example, when the error signal is greater than the ramp signal, the output of PWM comparator 220 may be set to a high level. As the voltage of the ramp signal ramps up, the error signal may become lower than the ramp signal, and the output of PWM comparator 220 may be set to a low level. Therefore, a series of pulses may be generated at the output of PWM comparator 220. The pulse may be longer (wider) when the error signal is much higher than the ramp signal and thus it may take a longer time for the ramp signal to ramp up and reach the voltage level of the error signal.

In the example shown in FIG. 2, latch 230 may latch the pulse signal generated by PWM comparator 220 and provided to the Reset (R) input of latch 230 based on a clock signal 232 at the Set(S) input of latch 230. For example, the output of latch 230 may be set to a high level at each rising edge of the clock signal (which in some examples may be aligned with a falling edge of the sawtooth ramp signal and/or a rising edge of a pulse of the pulse signal generated by PWM comparator 220). The output of latch 230 may be reset to a low level at an edge (e.g., a falling edge) of a pulse of the pulse signal. Therefore, the start of a new switching cycle may be determined by the clock signal, and the modulated pulse signal may have a constant pulse frequency but a variable pulse width, and hence may be a PWM signal.

Driver 240 may generate control signals for high-side switch 250 and low-side switch 252 based on the modulated pulse signal generated by latch 230. For example, the control signal for high-side switch 250 and the control signal for low-side switch 252 may be complementary to each other such that low-side switch 252 may be switched off when high-side switch 250 is switched on, and may be switched on when high-side switch 250 is switched off.

When there is a sudden change in the load current of power converter 200, the load current may not all be provided from the power source (that provides the input voltage VIN) through high-side switch 250 and inductor 254. At least a portion of the load current may be supplied by discharging one or more capacitors 256. Therefore, the output voltage V_{OUT} across capacitors 256 may drop, and thus the feedback voltage V_{FB} may drop as well. The drop in the feedback voltage V_{FB} would cause the error signal at the output of error amplifier 210 to increase due to the increase in the voltage difference between the reference voltage V_{REF} and the feedback voltage V_{FB}. The increase in the error signal may cause the duty cycle of the modulated pulse signal to increase, such that high-side switch 250 may be turned on for a longer time period to pull up the output voltage and supply the increased load current.

Due to the latency of the control loop and the integration of the error, the integrated error signal at the output of error amplifier 210 may increase at a lower rate than the increase in the load current and the voltage drop at output voltage V_{OUT}, and thus the duty cycle of the modulated pulse signal and the current supplied by the input voltage VIN through inductor 254 may increase slowly, such that the output voltage V_{OUT} may continue to drop. In addition, since the switching is at a constant frequency set by the clock signal, the response to the load transient may also be limited by the clock frequency, which may further limit the bandwidth and response time of the control loop. For example, even if the error signal can increase more quickly, the high-side switch 250 may wait for the next clock cycle to turn on, during which the output voltage may continue to drop. As such, the drop at output voltage V_{OUT} may be large and may take a longer time to recover.

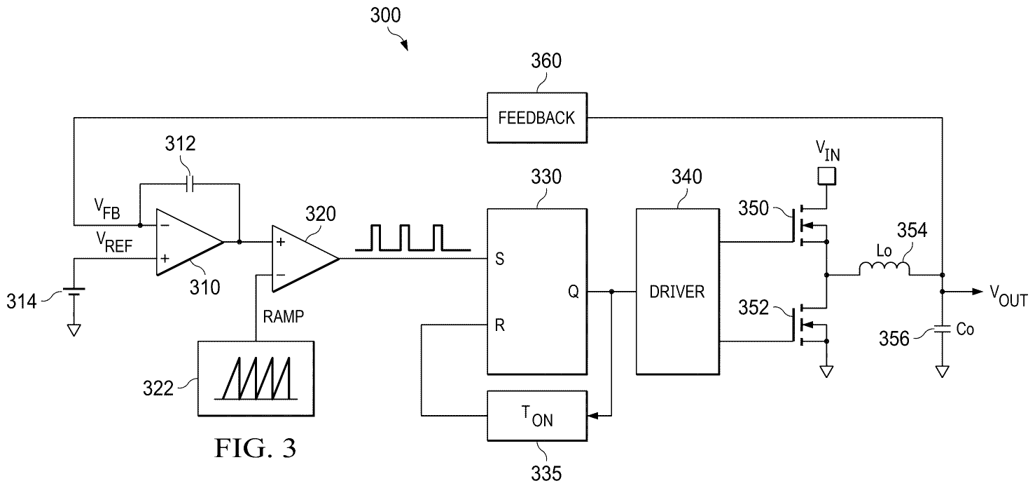

FIG. 3 is a schematic of an example of a constant-on-time (COT) power converter 300. In the illustrated example, power converter 300 may include an error amplifier 310, a PWM comparator 320, a latch 330, a driver 340, a power stage, and a feedback circuit 360, which may be on a same semiconductor die in some examples. An LC filter may be used at the output of the power stage to stabilize an output voltage V_{OUT} for driving a load, such as an integrated circuit 110, 112, or 114. The LC filter may include an inductor 354 and one or more capacitors 356. In some examples, inductor 354 and capacitor(s) 356 may be discrete components mounted on a PCB. The power stage may include a high-side switch 350 (e.g., a MOSFET) and a low-side switch 352 (e.g., a MOSFET), which may operate in a manner similar to the operations of high-side switch 250 and low-side switch 252. The output voltage V_{OUT} may be proportional to the input voltage VIN and the duty cycle of the on-time of high-side switch 350, and thus may be regulated by adjusting the duty cycle of the on-time of the switches based on the difference between a target output voltage level and the actual output voltage level at the load. The control signal for controlling the switching of high-side switch 350 and low-side switch 352 may be generated by a control loop that includes error amplifier 310, PWM comparator 320, latch 330, driver 340, the power stage, and feedback circuit 360.

Error amplifier 310 may be similar to error amplifier 210, and may include a first input coupled to feedback circuit 360, a second input coupled to a reference voltage source 314, and a negative feedback circuit that may be coupled to the first input and the output of error amplifier 310. Feedback circuit 360 may include, for example, a voltage divider that may divide the output voltage (VOLT) at the load to generate a scaled down feedback voltage (V_{FB}) that may be a fraction of the output voltage at the load. The negative feedback circuit may include at least a capacitor 312 (or a capacitor and a serial resistor), such that error amplifier 310 may function as an integrator (and a low-pass filter) that may integrate the difference between the feedback voltage (V_{FB}) and a reference voltage V_{REF} generated by reference voltage source 314 to amplify and filter the error and generate an integrated error signal at the output of error amplifier 310.

PWM comparator 320 may include a first input coupled to the output of error amplifier 310, a second input coupled to a ramp generator 322, and an output coupled to latch 330. Ramp generator 322 may generate a sawtooth ramp signal. In some examples, ramp generator 322 may generate the sawtooth ramp signal based on a clock signal. In some examples, ramp generator 322 may generate the sawtooth ramp signal based on a sensed current (which may have a sawtooth shape) at the power stage or load (e.g., inductor 354) of power converter 300. PWM comparator 320 may compare the voltage levels of the error signal and the ramp signal, and generate a pulse signal at the output of PWM comparator 320. For example, when the error signal is greater than the ramp signal, the output of PWM comparator 320 may be set to a high level. As the voltage of the ramp signal ramps up, the error signal may become lower than the ramp signal, and the output of PWM comparator 320 may be set to a low level. Therefore, a series of pulses may be generated at the output of PWM comparator 320. The pulse may be longer (wider) when the error signal is much higher than the ramp signal and thus it may take a longer time for the ramp signal to ramp up and reach the voltage level of the error signal.

In the example shown in FIG. 3, latch 330 may latch the pulse signal generated by PWM comparator 320, and a timer 335 that may set an on-time (or pulse width) of the pulses in a modulated pulse signal by providing a reset signal to the Reset (R) input of latch 330. For example, the output of latch 330 may be set to a high level at the rising edge of each pulse of the pulse signal generated by PWM comparator 320 and provided to the Set(S) input of latch 330, and may be reset to a low level after a time delay set by timer 335. In some examples, the time delay set by timer 335 may be a constant value, and thus the pulses in the modulated pulse signal may have a constant width and hence the on-time of high-side switch 350 may be constant in each switching cycle, such that power converter 300 may be a constant on-time (COT) power converter. In some examples, the time delay set by timer 335 may be dynamically adjusted, and thus the pulses in the modulated pulse signal may be dynamically adjusted and the on-time of high-side switch 350 may also be dynamically adjusted in each switching cycle. In either cases, the modulated pulse signal may have a variable switching frequency (or variable pulse density).

Driver 340 may generate control signals for high-side switch 350 and low-side switch 352 based on the modulated pulse signal generated by latch 330. For example, the control signal for high-side switch 350 and the control signal for low-side switch 352 may be complementary to each other such that low-side switch 352 may be switched off when high-side switch 350 is switched on, and may be switched on when high-side switch 350 is switched off.

When there is a sudden change in the load current of power converter 300, the load current may not all be provided from the input voltage VIN through high-side switch 350 and inductor 354. At least a portion of the load current may be supplied by discharging one or more capacitors 356. Therefore, the output voltage V_{OUT} across capacitors 356 may drop, and thus the feedback voltage V_{FB} may drop as well. The drop in the feedback voltage V_{FB} would cause the error signal at the output of error amplifier 310 to increase due to the increase in the voltage difference between the reference voltage V_{REF} and the feedback voltage V_{FB}. The increase in the error signal may cause the switching frequency of the modulated pulse signal to increase, such that high-side switch 350 may be turned on more frequently to pull up the output voltage. Since the output of the modulated pulse signal at the output of latch 330 and thus the switching of the high-side switch 350 may not wait for the next clock cycle, high-side switch 350 may be switched on more quickly and more frequently, thereby pulling up the output voltage more quickly. Therefore, the on time of high-side switch 350 may be constant, but the switching frequency or period of high-side switch 350 in power converter 300 may not be constant due to the variations in the off time of high-side switch 350.

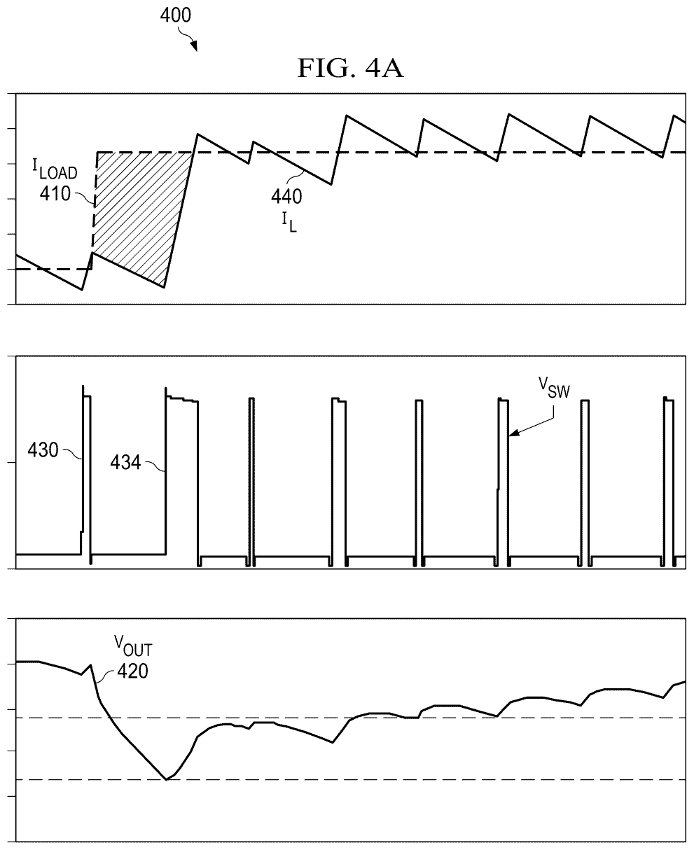

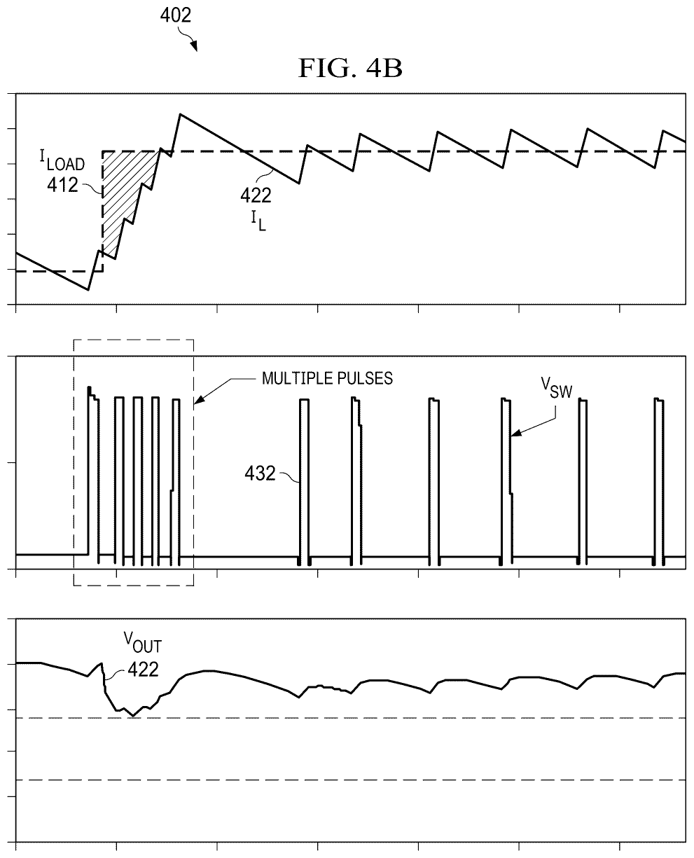

FIG. 4A is a diagram 400 illustrating an example of operations of a voltage mode or current mode power converter (e.g., power converter 200) in response to a load current step-up. In diagram 400, a waveform 410 shows an example of a step-up in the load current of the power converter. A waveform 420 shows the output voltage of the power converter. A waveform 430 shows the modulated pulse signal for controlling the switches in the power stage. A waveform 440 shows the current supplied by the power converter through an output inductor (e.g., output inductor 254). The load current step-up causes the output voltage of the power converter to drop as shown by waveform 420. The drop in the output voltage may cause the PWM comparator to generate a pulse with a higher width. However, the modulated pulse signal and thus the power stage may not switch until the rising edge of the next clock cycle. Therefore, the output voltage may continue to drop before the rising edge of the next clock cycle, and the current that the power converter may supply through the inductor may be lower than the load current. The difference between the load current and the current passing through the inductor may be provided by the output capacitors (e.g., capacitors 256).

At the rising edge of the next clock cycle, the output of the latch may be set to a high value to generate a pulse 434 in the modulated pulse signal outputted by the latch. Pulse 434 may cause the high-side switch to turn on to draw current from the input voltage and pull up the output voltage. Pulse 434 may have a higher width so that the high-side switch may be turned on for a longer time period to pull up the output voltage and increase the current supplied from the input voltage through the inductor. However, because the modulated pulse signal and thus the high-side switch of the power stage may not switch until the rising edge of the next clock cycle, the output voltage may drop to a low level to cause a large ripple in the output voltage supplied to the load as shown by waveform 430. In diagram 400, the shaded area shows the difference between the load current and the current provided by the power converter through the inductor, where the difference may be supplied by the output capacitors (e.g., capacitors 256). Therefore, the output capacitors may be discharged and the output voltage across the output capacitors may drop to cause undershoot. To reduce the undershoot, the total capacitance value of the output capacitors may be increased.

FIG. 4B is a diagram 402 illustrating an example of operations of a COT power converter (e.g., power converter 300) in response to a load current step-up. In diagram 402, a waveform 412 shows an example of a step-up in the load current of the power converter. A waveform 422 shows the output voltage of the power converter. A waveform 432 shows the modulated pulse signal for controlling the switches in the power stage. A waveform 442 shows the current supplied by the power converter through the inductor. The load current step-up causes the output voltage of the power converter to drop as shown by waveform 422. The drop in the output voltage may cause the PWM comparator to generate a pulse. As soon as the latch detects the transition from a low voltage level to a high voltage level at the output of the PWM comparator, the output of the latch may be set to a high level to turn on the high-side switch, such that the power stage may draw current from the input voltage and pull up the output voltage. The output of the latch may be reset to a low level after a constant delay (the constant on time), which may turn off the high-side switch of the power stage. Since the output voltage may still be lower than the target voltage, the PWM comparator may generate another pulse. The transition from the low voltage level to the high voltage level at the output of the PWM comparator may cause the latch to set the output to a high level again to turn on the high-side switch. In this way, when the output voltage is lower than the target voltage, the switching frequency of the high-side switch of the power stage may be increased as shown by waveform 432, such that the output voltage and the current supplied by the power stage through the inductor may increase more quickly to reach the target values.

The shaded area in diagram 402 shows the difference between the load current and the load current provided by the power converter through the inductor, where the difference may be supplied by the output capacitors (e.g., capacitor 256). Therefore, the output capacitors may be discharged to supply the current, and the output voltage across the output capacitors may drop to cause undershoot. As shown by FIGS. 4A and 4B, the voltage drop at the output of the power converter may be much lower in the COT power converter (e.g., power converter 300) compared with the voltage mode or current mode buck converter (e.g., power converter 200). In addition, as shown by FIGS. 4A and 4B, the differences between the load current and the current provided by the power converter through the inductor in the COT power converter (e.g., power converter 300) may be much lower than those in power converter 200 shown in FIG. 2. Therefore, for the same tolerable voltage drop at the output, the total capacitance value of the output capacitors in power converter 300 can be lower than that in power converter 200.

In some electrical systems, multiphase power converters, such as multiphase buck converters, may be used to meet the high power demands. A multiphase buck converter may include a set of power phases, each with its own inductor and a set of transistors (e.g., in a half bridge configuration) that collectively form a power phase. The set of power phases may be connected in parallel and share both the input and output capacitors. During steady-state operations, individual power phases may be active at interleaved intervals equal to about 360°/N throughout the switching period, where N is the total number of power phases. Compared with a single-phase power converter, a multiphase power converter can provide high output currents, improved thermal performance and efficiency at high load currents, and reduced undershoot and overshoot during load transients, and may use lower input capacitance and/or output capacitance while maintaining equivalent ripple performance.

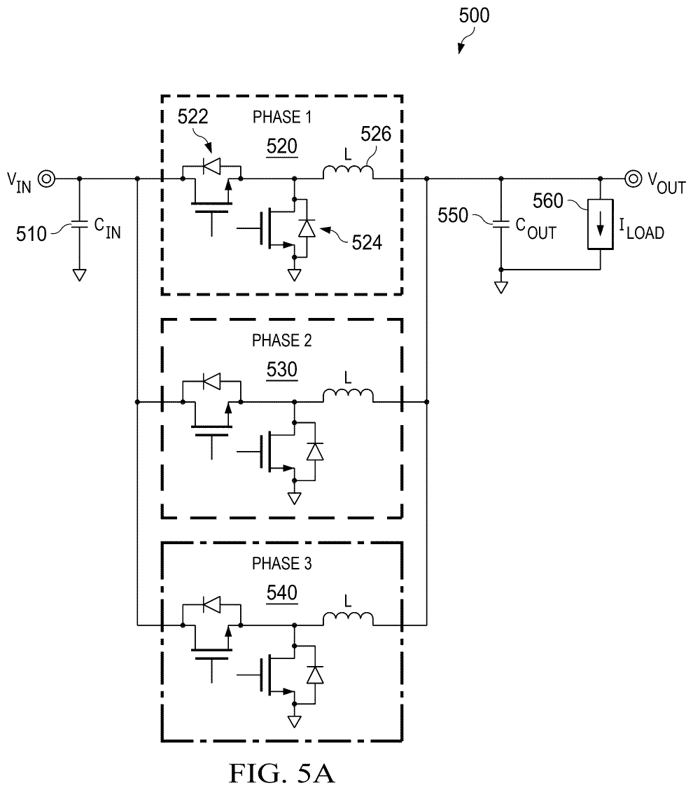

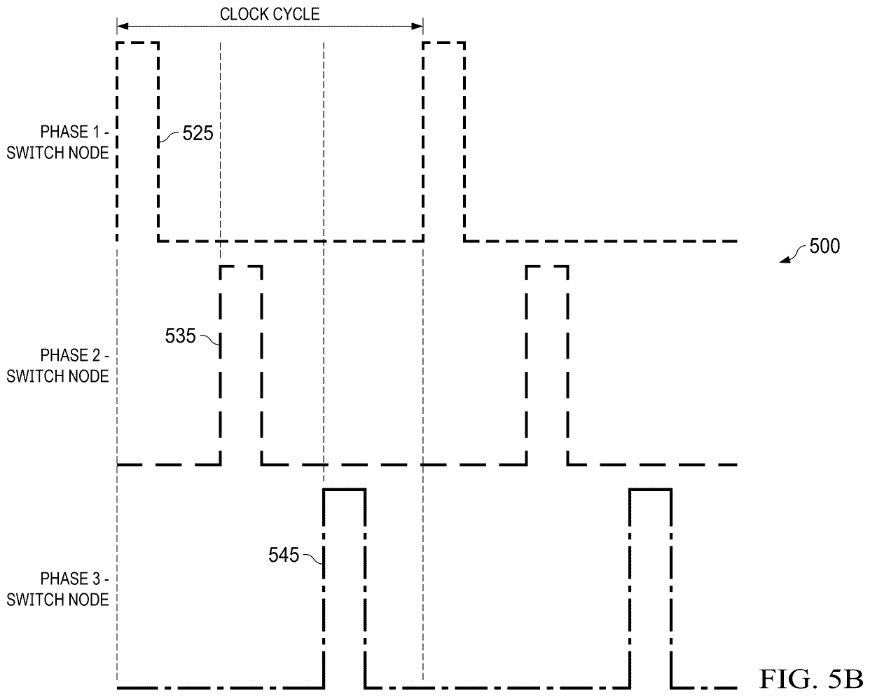

FIG. 5A is a schematic of multiple power phases of an example of a multiphase power converter 500. Multiphase power converter 500 may include a controller (not shown in FIG. 5A) that generates control signals for controlling the power stages in the power phases. In the illustrated example, the power phases of multiphase power converter 500 may include a first power phase 520, a second power phase 530, and a third power phase 540 connected in parallel. In other examples, multiphase power converter 500 may include more or fewer power phases, such as 2 power phases, 4 power phases, or more power phases. The inputs of the multiple power phases may be coupled to the input port VIN of multiphase power converter 500 and one or more input capacitors 510. The outputs of the multiple power phases may be coupled to the output port V_{OUT} of multiphase power converter 500, one or more output capacitors 550, and a load 560. Each power phase may include a power stage that includes a first transistor 522 (or another switch device), a second transistor 524 (or another switch device), and an inductor 526. The drain of first transistor 522 may be coupled to input voltage VIN, the source of first transistor 522 may be coupled to inductor 526, and the gate of first transistor 522 may be coupled to the controller. The drain of second transistor 524 may be coupled to both the source of first transistor 522 and inductor 526, the source of second transistor 524 may be coupled to ground, and the gate of second transistor 524 may be coupled to the controller. One terminal of inductor 526 may be coupled to the source of first transistor 522 and the drain of second transistor 524. Another terminal of inductor 526 may be coupled to capacitor(s) 550 and load 560.

FIG. 5B illustrates examples of control signals for controlling the power phases of multiphase power converter 500. A waveform 525 in FIG. 5B shows the control signal for controlling the first transistor (e.g., a high-side switch) of first power phase 520. A waveform 535 shows the control signal for controlling the first transistor (e.g., a high-side switch) of second power phase 530. A waveform 545 shows the control signal for controlling the first transistor (e.g., a high-side switch) of third power phase 540. As illustrated, the pulses for switching the high-side switches of the three power phases may have different phases within a clock cycle, where the pulse for switching the high-side switch of first power phase 520 may be about ⅓ clock cycles (or) 120° earlier than the pulse for switching the high-side switch of second power phase 530, which may in turn be about ⅓ clock cycles (or) 120° earlier than the pulse for switching the high-side switch of third power phase 540. In this way, the three power phases may be turned on sequentially in each clock cycle to drive the output at different time.

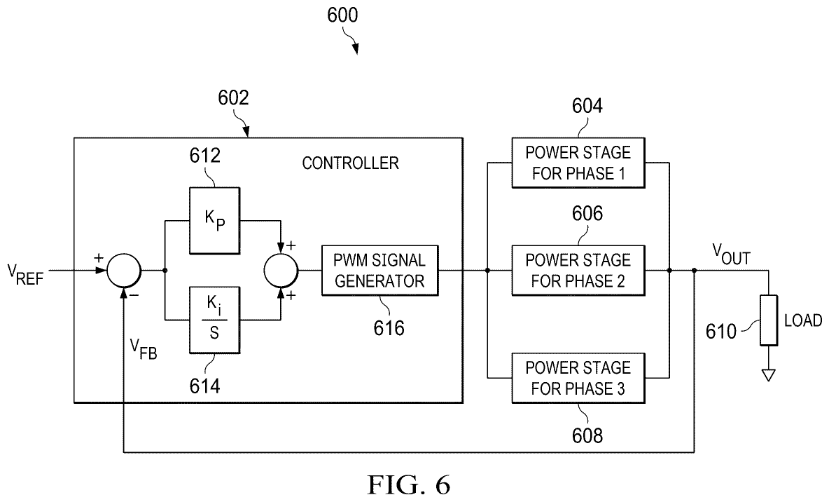

FIG. 6 is a block diagram of an example of a centralized COT (CCOT) multiphase power converter 600. CCOT multiphase power converter 600 may include a controller 602 and multiple power phases, such as a first power phase 604, a second power phase 606, and a third power phase 608. Controller 602 may be a centralized controller that generates control signals for the multiple power phases. Each power phase of the multiple power phases may include a power stage that may include a gate driver, a half bridge, and an inductor as shown in FIGS. 2 and 3, and may be used to drive a load 610 during a time period in each clock cycle as described above with respect to FIGS. 5A and 5B. CCOT multiphase power converter 600 may also include a feedback path that provides a feedback voltage V_{FB} to controller 602. The feedback voltage V_{FB} may be equal to or proportional to (e.g., a fraction of) the output voltage V_{OUT} at load 610. CCOT multiphase power converter 600 may also include a reference voltage generator (e.g., a bandgap reference voltage generator) that may generate a reference voltage V_{REF}, or may receive the reference voltage V_{FB} from other circuits in the system.

In the example illustrated in FIG. 6, controller 602 may include a proportional controller 612, an integral controller 614, and a PWM signal generator 616. Proportional controller 612 may generate a first error signal that is proportional to the difference between the feedback voltage V_{FB} and the reference voltage V_{REF}, while integral controller 614 may generate a second error signal that is an integration (or cumulative sum) of the difference between the feedback voltage V_{FB} and the reference voltage V_{REF}. The second error signal may include residual steady-state errors that persist over time. The first error signal and the second error signal may be summed to generate a third error signal that may be used by PWM signal generator 616 to generate control signals for controlling first power phase 604, second power phase 606, and third power phase 608. PWM signal generator 616 may include, for example, a PWM comparator, a latch, an on-time control circuit, and/or a buffer or driver, as described above with respect to FIGS. 2 and 3. In some examples, controller 602 may be a PID controller that may also include a derivative controller (not shown) in addition to proportional controller 612 and integral controller 614. The derivative controller may generate a fourth error signal that predicts future errors based on, for example, the rate of change of the error. The fourth error signal may be added to the third error signal to generate an overall error signal that may then be used by PWM signal generator 616 to generate control signals for controlling first power phase 604, second power phase 606, and third power phase 608. The control signals for each power phase may be sent to the power phase through a respective control signal path (e.g., a trace on a PCB). When a CCOT multiphase power converter includes many power phases, many control signal paths may be routed on the PCB.

In various examples, the controller may process the error signals in the analog domain or in the digital domain. In examples where the controller processes the error signals in the analog domain, proportional controller 612 and integral controller 614 may include, for example, an amplifier (e.g., an operational amplifier) with a suitable feedback network (e.g., a resistive feedback network for proportional controller 612, a feedback network including a capacitor for integral controller 614). In examples where the controller processes the error signals in the digital domain, controller 602 may include an analog to digital converter (ADC) to convert the error signals into digital values. Controller 602 may also include digital logic circuit (e.g., a digital signal processor, a microcontroller, or other application specific integrated circuit (ASIC)) to perform computations on the digital values of the error signals to implement proportional controller 612 and integral controller 614.

In CCOT multiphase power converter 600, a centralized PWM signal generator (e.g., PWM signal generator 616) is used to generate the switching control signals for all (e.g., N) power phases. Therefore, the centralized PWM signal generator (e.g., including the PWM comparator and the latch) would operate at a clock frequency that is N times of the switching frequency of each power stage. Therefore, CCOT multiphase power converter 600 may not be able to support a large number of power phases for a high load current at least due to the limitation of the operating frequency of the centralized PWM signal generator.

As described above with respect to, for example, FIG. 5, each power phase of first power phase 604, second power phase 606, and third power phase 608 may include a power stage that may include a high-side switch (e.g., first transistor 522), a low-side switch (e.g., second transistor 524), and an inductor (e.g., inductor 526). In some examples, each power phase may include a local driver that may receive a control signal from controller 602 and generate control signals for controlling both the high-side switch and the low-side switch. The high-side switch may be coupled between an input voltage and the inductor, and may be controlled by a control signal. The low-side switch may be coupled between the inductor and ground, and may be controlled by a control signal. A terminal of the inductor may be coupled to both the high-side switch and the low-side switch. Another terminal of the inductor may be coupled to output capacitors and the load of the power converter.

In CCOT multiphase power converter 600 (and power converter 200 or 300), the control loop may include an integral controller (e.g., integral controller 614, or a PID controller that may also include a proportional controller and/or a derivative controller), a PWM signal generator (e.g., PWM signal generator 616), a buffer or a driver for driving multiple power phases, an interconnect between the centralized controller and each power phase, a local gate driver, a half bridge, an inductor, and a feedback path. Each component of the control loop may introduce a time delay. For example, the integral controller may introduce a relatively long delay. When the multiphase power converter includes many power phases, at least some power phases may be placed far away from the centralized controller due to layout limitation. Therefore, the interconnect may be long, the buffer may be large in order to drive the long interconnect, and the feedback path may be long as well. As such, the latency of the entire control loop may be long (e.g., longer than 50 ns), and thus the response time of the power converter may be long and the bandwidth of the power converter may be low.

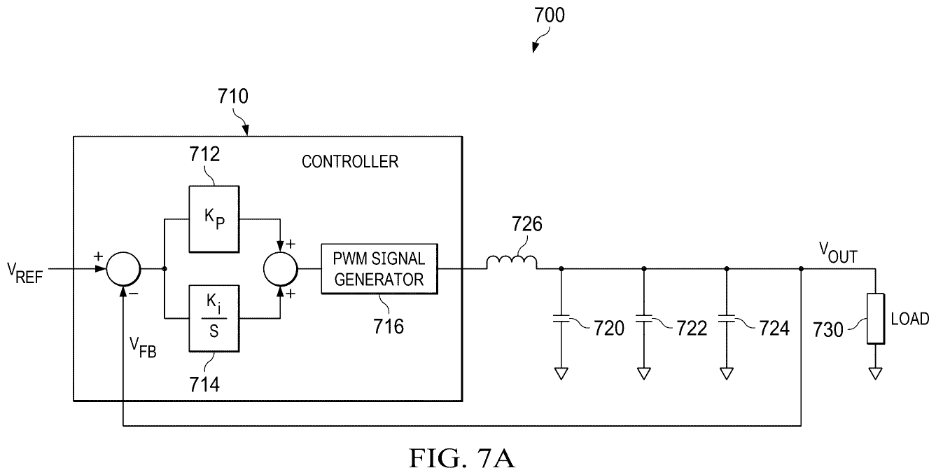

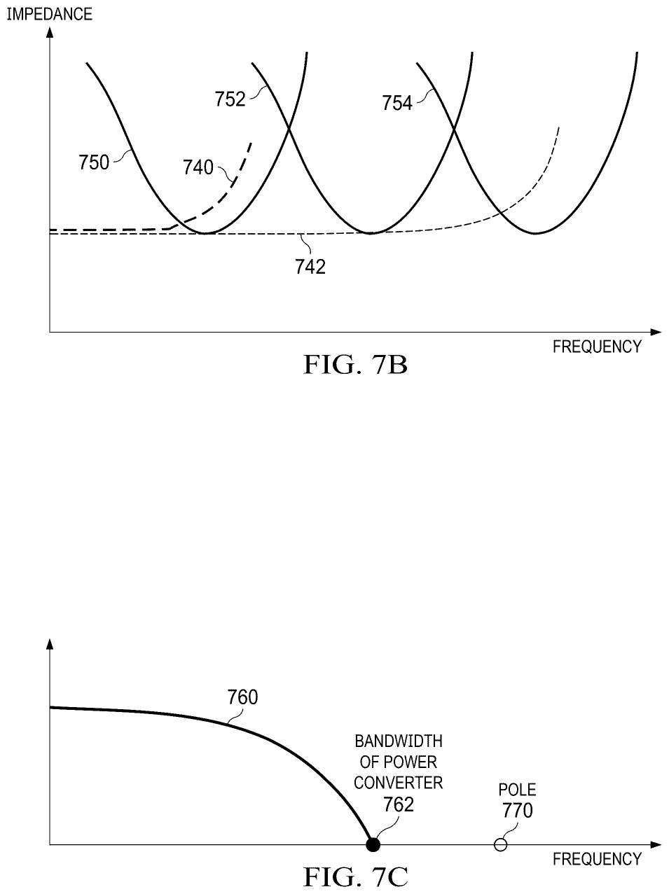

FIG. 7A is a block diagram of an example of a system 700 that includes a power converter 710. Power converter 710 may be an example of power converter 200 or 300, or CCOT multiphase power converter 600. In system 700, power converter 710 may be used to drive a load 730 through an LC network that may include a plurality of capacitors 720, 722, . . . , and 724 and an inductor 726. Power converter 710, capacitors 720, 722, . . . , and 724, and inductor 726 are parts of the power distribution network (PDN) of system 700. Power converter 710 may include a proportional controller 712, an integral controller 714, and a block 716 that may include a PWM signal generator and one or more power stages. As described above, proportional controller 712 and integral controller 714 may process the error signals in the analog domain (e.g., including one or more amplifiers with feedback networks) or in the digital domain (e.g., including digital logic circuits to perform computations). Each power stage may include a gate driver, a half bridge, and an inductor as shown in FIGS. 2 and 3. In some example, inductor 726 may be part of the power stage. Power converter 710 may also include a feedback path that provides a feedback voltage V_{FB} to proportional controller 712 and integral controller 714. The feedback voltage V_{FB} may be equal to or proportional to (e.g., a fraction of) the output voltage V_{OUT} at load 730. Proportional controller 712 may receive feedback voltage V_{FB}, and generate a first error signal that is proportional to the difference (error) between the feedback voltage V_{FB} and a reference voltage V_{REF}. Integral controller 714 may also receive the feedback voltage V_{FB}, and generate a second error signal that is an integration (or cumulative sum) of the difference (error) between the feedback voltage V_{FB} and the reference voltage V_{REF}. Thus, the second error signal may include residual steady-state errors that persist over time. The first error signal and the second error signal may be summed to generate a third error signal that may be used by the PWM signal generator of block 716 to generate control signals for controlling one or more power phases in block 716 as described above with respect to FIGS. 2, 3, and 6. In examples where power converter 710 is a multiphase power converter that includes multiple power stages connected in parallel, each power stage may include a respective inductor at the output, and inductor 726 may not be used.

FIG. 7B illustrates an example of impedance profiles of components of the PDN of system 700 of FIG. 7A. In FIG. 7B, the horizontal axis corresponds to the signal frequency, and the vertical axis corresponds to the impedance of the components of the power distribution network for signals of different frequencies. A curve 740 represents the output impedance profile a power converter 710, which may have low output impedances at DC and low frequency, but may have high output impedances for high frequency signals. In the illustrated example, power converter 710 may have a low bandwidth, the output impedance of power converter 710 may start to increase quickly at relatively low frequency, and power converter 710 may not be able to respond to rapid changes in the load current. As described above, it is desirable to keep the overall output impedance of the power distribution network low from DC to a high frequency to reduce the voltage drop in the power distribution network and achieve a high bandwidth and thus a fast response for load transient.

Capacitors 720, 722, . . . , and 724 may be used to reduce the overall output impedance of the PDN and supply current quickly in response to high frequency changes in the load current. A curve 750 in FIG. 7B represents the impedance profile of capacitor 720, which may have a large capacitance and thus a large size. Due to the large capacitance, the impedance of capacitor 720 may decrease as the signal frequency increase from DC and may reach a low impedance. However, due to the large size (e.g., length) and thus large serial parasitic inductance of capacitor 720, the impedance of the parasitic inductor may become dominant as the signal frequency increases, such that the overall impedance of capacitor 720 may increase as the signal frequency increases. A curve 752 represents the impedance profile of capacitor 722, which may have a medium capacitance and a medium size. The impedance profile of capacitor 722 may have a similar shape as the impedance profile of capacitor 720, but may have a minimum impedance at a higher frequency due to the lower capacitance and lower parasitic inductance. A curve 754 represents the impedance profile of capacitor 724, which may have a small capacitance and a small size. The impedance profile of capacitor 724 may have a similar shape as the impedance profile of capacitor 720 or 722, but may have a minimum impedance at an even higher frequency due to the small capacitance and small parasitic inductance of capacitor 724. The overall impedance profile of the PDN may be a combination of the impedances of the parallelly connected power converter 710 and capacitors 720, 722, . . . , and 724, and other components of the PDN. When capacitors 720, 722, . . . , and 724 are selected properly, the overall impedance profile of the PDN can be low from DC to a high frequency.

When the power converter has a low bandwidth and thus a long response time and high output impedance at a relative low frequency, more capacitors with larger capacitance values may be used to reduce the overall output impedance of the power distribution network. More capacitors with larger capacitance values may use larger areas on the PCB and increase the cost of the system. By increasing the bandwidth and reducing the output impedance of the power converter, large capacitors may be eliminated from the system, while a low overall output impedance of the PDN may be maintained in a target frequency range. For example, if the bandwidth of power converter 710 can be increased such that the output impedance profile of power converter 710 may be represented by a curve 742, capacitors 720 and 724 can be removed from the system while the overall output impedance of the PDN can still be low in a target frequency range and the ripple performance of the power converter can be maintained.

FIG. 7C illustrates an example of an frequency response of a power converter. In FIG. 7C, the horizontal axis corresponds to the signal frequency, and the vertical axis corresponds to the gain of the power converter. A curve 760 shows the frequency response of the power converter, where the unity-gain bandwidth may be at a frequency 762. The delay in the control loop of power converter 710 may provide a pole at a frequency 770. The pole may limit the overall bandwidth of the power converter that can have sufficient phase margin and stability. Reducing the delay in the control loop can move the pole to a higher frequency and increase the bandwidth of the power converter, while maintaining the phase margin and stability.

According to some examples, to increase the bandwidth and reduce the high-frequency output impedance thereby improving the transient response and reducing decoupling capacitance, a multiphase power converter may include a central controller configurable to generate a low bandwidth signal to be shared among multiple power stages, and may also include a plurality of local controllers close to corresponding power stages to form local feedback loops that have lower latency, higher bandwidths, and faster transient response. In some examples, the central controller may include an integral controller (Ki) to generate a DC or low-frequency loop control signal that may be an integral of a difference (error) between a reference voltage and the sensed output voltage of the power converter. In some examples, the central controller may include a PID controller that may also include a proportional controller and/or a derivative controller. The DC or low-frequency loop control signal (e.g., an error signal) may be shared by all power phases.

Each local controller may include a proportional controller (Kp) implemented locally at each power phase to provide a local AC feedback loop to reduce the loop delay and improve the loop bandwidth, thereby improving the transient response of the power converter. Each local AC feedback loop or local controller may include, for example, a proportional controller (e.g., a proportional amplifier), a comparator, an on-time modulation and phase shift stage, and a gate driver. Each local AC loop can sense the output voltage locally (at the power stage) or at the load. The proportional controller may generate an output error signal that may be proportional to the error of the output voltage (e.g., with respect to a reference voltage). The comparator may compare the output error signal with a ramp signal to generate a pulse signal that includes pulses for switching the switches in the power stage of each power phase. The on-time modulation and phase shift stage may modulate the on-time (e.g., pulse width or pulse density) of the pulses, and may also modulate the phase of the pulses with respect to the phases of the modulated pulse signals for other power stages based on a common reference clock from the central controller, to achieve good transient and DC performance. The gate driver may drive the modulated pulse signal to control the switches (e.g., MOSFETs) of the power stage. In some examples, the local controller may also include a circuit that may sense the current of the power stage, compare the current with an average current of the power stages of the multiple power phases, and generate an input signal for the comparator, thereby modulating the pulse signal to balance the current load between the power phases.

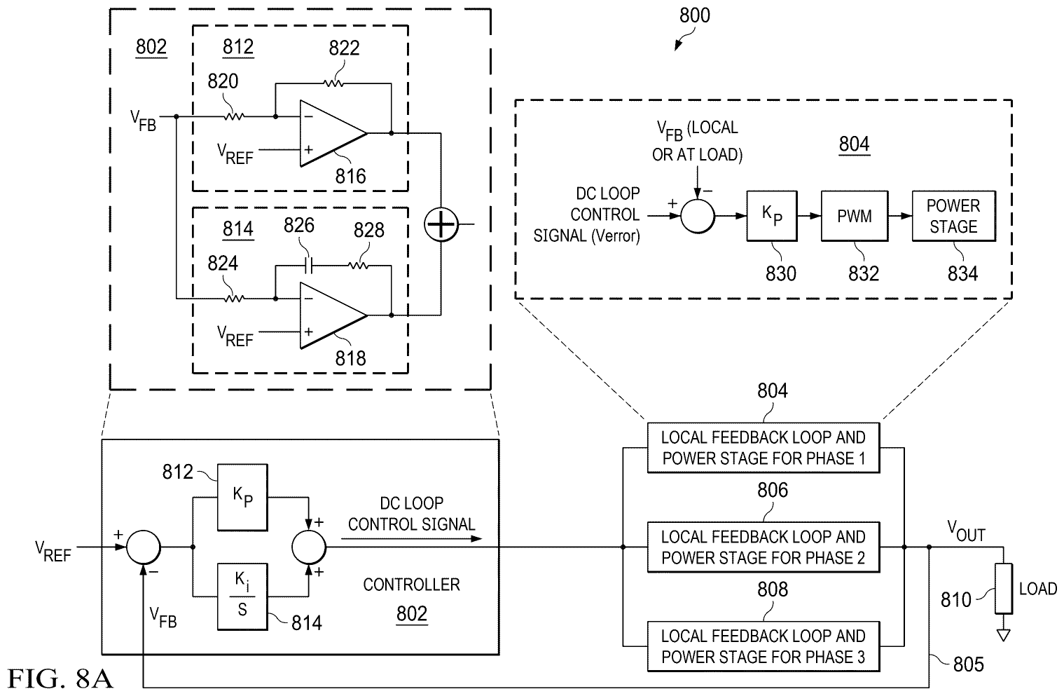

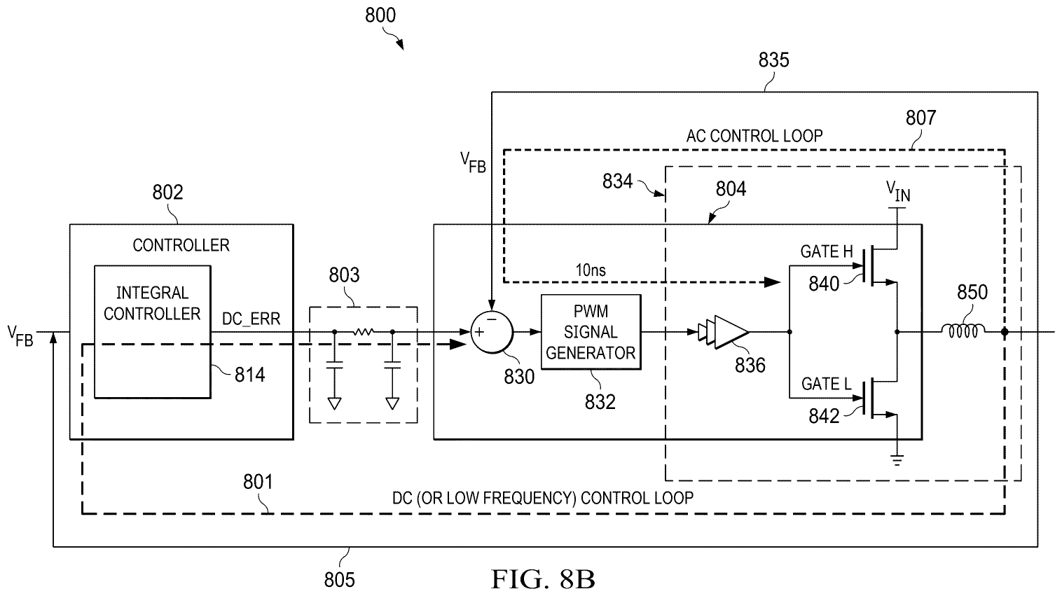

FIG. 8A is a block diagram of an example of a distributed COT (DCOT) multiphase power converter 800. DCOT multiphase power converter 800 may include a central controller 802 and multiple power phases each including a local controller and a power stage, such as a first power phase 804, a second power phase 806, and a third power phase 808. Central controller 802 may generate an error signal that may be shared by the multiple power phases. DCOT multiphase power converter 800 may also include a feedback path 805 that provides a feedback voltage V_{FB} to central controller 802. The feedback voltage V_{FB} may be equal to or proportional to (e.g., a fraction of) the output voltage V_{OUT} at load 810. DCOT multiphase power converter 800 may also include a reference voltage generator (e.g., a bandgap reference voltage generator) that may generate a reference voltage V_{REF}, or may receive the reference voltage V_{REF} from other circuits in the system.

In the example illustrated in FIG. 8, central controller 802 may include an optional proportional controller 812 and an integral controller 814. Proportional controller 812 may generate a proportional error signal that is proportional to the difference (error) between the feedback voltage V_{FB} and the reference voltage V_{REF}, while integral controller 814 may generate an integral error signal that is an integration (or cumulative sum) of the difference between the feedback voltage V_{FB} and the reference voltage V_{REF}. The integral error signal may include residual steady-state errors that persist over time. The proportional error signal and the integral error signal may be summed to generate an error signal that may be used as a DC or low-frequency loop control signal by the local controller in each power phase to generate control signals for controlling the corresponding power stage. In some examples, central controller 802 may be a PID controller that may also include a derivative controller (not shown) in addition to integral controller 814 and/or proportional controller 812. The derivative controller may generate a derivative error signal that predict future errors based on, for example, the rate of change of the error. The derivative error signal may be added to the DC loop control signal that may be sent to each local controller of the multiple power phases.

In one example, proportional controller 812 may operate in the analog domain and include an amplifier 816, an input resistor 820 coupled to the negative input of amplifier 816, a feedback resistor 822 between the negative input and the output of amplifier 816, where resistors 820 and 822 form a resistive feedback network. The positive input of amplifier 816 may be coupled to the reference voltage V_{REF}. Therefore, the output voltage of amplifier 816 may include a portion that is proportional to the difference between the feedback voltage V_{FB} and reference voltage V_{REF}, and the ratio between feedback resistor 822 and input resistor 820. Integral controller 814 may also operate in the analog domain and include an amplifier 818, an optional input resistor 824 coupled to the negative input of amplifier 818, and a capacitor 826 and an optional resistor 828 between the negative input and the output of amplifier 818, where resistors 824 and 828 and capacitor 826 form a capacitive feedback network. The positive input of amplifier 818 may be coupled to the reference voltage V_{REF}. Therefore, the output voltage of amplifier 818 may include a portion that is an integration of the difference between the feedback voltage V_{FB} and reference voltage V_{REF}. In some examples, central controller 802 may include a single amplifier (e.g., one of 816 or 818), with the resistive and capacitive feedback networks coupled in parallel between a first input (to receive feedback voltage V_{FB}) and an output of the amplifier, while a second input of the amplifier receives the reference voltage V_{REF}. In some examples, proportional controller 812 and integral controller 814 may operate in the digital domain, where the controllers may include ADCs to convert V_{REF} and V_{FB} into digital values, and digital logic circuits to compute digital values of sums of an integral of error signal between V_{REF} and V_{FB} and a scaled version of the error signal to generate the low-frequency loop control signal. The controllers may also include a digital to analog converter (DAC) to convert the low-frequency loop control signal from digital domain to analog domain.

In one example, the local controller of each power phase may include a proportional controller 830, and a PWM signal generator 832. Proportional controller 830 may generate a local error signal that is proportional to the difference between the feedback voltage V_{FB} and the DC or low-frequency loop control signal generated by central controller 802. In some examples, proportional controller 830 may generate the local error signal by processing the feedback voltage and low-frequency loop control signal in analog domain (e.g., including an amplifier with a resistive feedback network, such as the example shown in FIG. 8A). In some examples, proportional controller 830 may generate the local error signal by processing the feedback voltage and low-frequency loop control signal in digital domain (e.g., by converting feedback voltage V_{FB} to digital values, and receiving low-frequency loop control signal in digital form). The PWM signal generator 832 may include a comparator that generates a pulse signal based on the difference between the local error signal and a ramp signal (and/or a sensed load current), and may also include a modulator that may modulate the phase, pulse width, and/or pulse density of the pulse signal to generate a modulated pulse signal for controlling a power stage 834. The modulator may include, for example, a latch and an on-time controller (e.g., a timer) as described above with respect to, for example, FIGS. 2 and 3, and described in more detail below. Power stage 834 can be close to the local controller in each power phase. Power stage 834 may include, for example, a half bridge, a gate driver that generates control signal for controlling the switch control terminals (e.g., gates) of two switches (e.g., MOSFETs) in the half bridge, and an output inductor.

FIG. 8B illustrates control loops in DCOT multiphase power converter 800. The control loops may include a DC (or low-frequency) control loop 801 and an AC (or high-frequency) control loop 807. DC control loop 801 may include central controller 802 (e.g., including integral controller 814 and a driver), an electrical interconnect 803 between central controller 802 and a power phase (e.g., first phase 804), the local controller of first phase 804 (e.g., including proportional controller 830 and PWM signal generator 832), power stage 834, and feedback path 805 that may be relatively long. Therefore, as described above, DC control loop 801 may have a long loop delay, and thus may have a slow response to load transients. AC control loop 807 may include proportional controller 830, PWM signal generator 832, power stage 834, and a feedback path 835 that may be relatively short. Therefore, AC control loop 807 may have a short loop delay (e.g., about 10 ns or shorter), and thus may have a quick response to load transients.

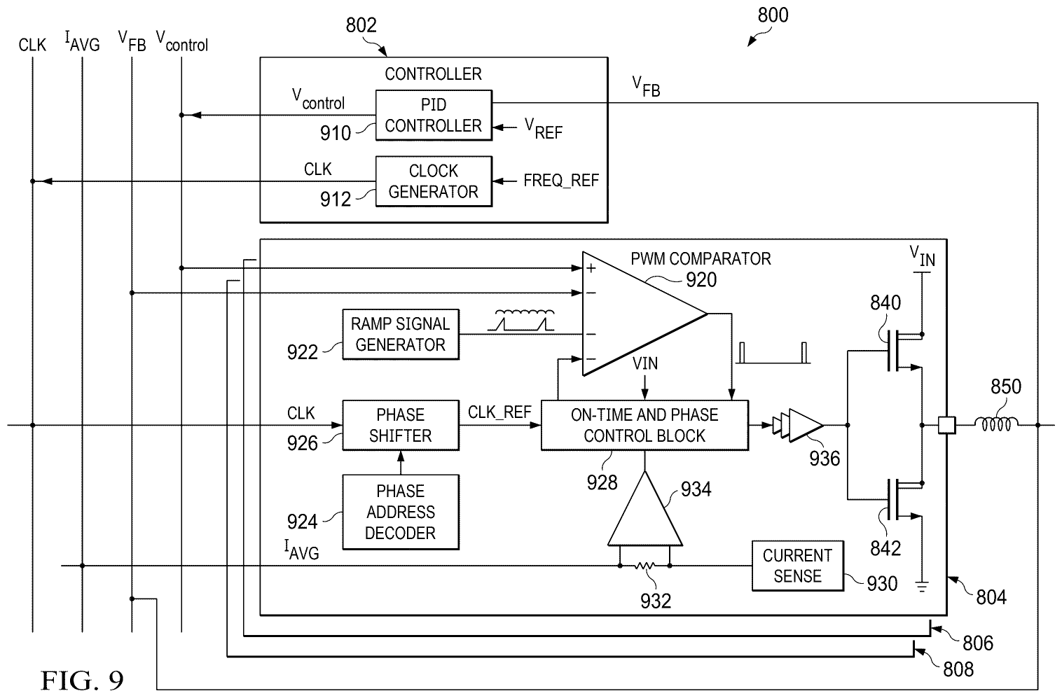

FIG. 9 is a schematic of an example of DCOT multiphase power converter 800. In the illustrated example, central controller 802 of DCOT multiphase power converter 800 may include a PID controller 910 and a clock generator 912. As described above, PID controller 910 may include an integral controller, a proportional controller, and/or a derivative controller. PID controller 910 may operate in analog or digital domains, as described above, and may generate an error signal V_{control} based on the feedback voltage V_{FB} of DCOT multiphase power converter 800 and the reference voltage V_{REF}. The error signal V_{control} may include an integration of the difference between the feedback voltage V_{FB} and the reference voltage V_{REF}. Clock generator 912 may generate a clock signal based on a frequency reference signal (e.g., from a crystal oscillator, a micro-electromechanical system (MEMS) oscillator, or a ring oscillator). The clock signal may be used to synchronize the power phases and the switching control signals for controlling the switches in the power stages.

Each power phase may include a PWM comparator 920, a ramp signal generator 922, and an on-time and phase control block 928. PWM comparator 920 may use the error signal V_{control}, feedback voltage V_{FB}, and a ramp signal generated by ramp signal generator 922 to generate a PWM signal. As describe above, ramp signal generator 922 may generated a sawtooth ramp signal based on a clock signal and/or a sensed current of the power stage or load. In some examples, PWM comparator 920 may generate the PWM signal based additionally on a signal generated by on-time and phase control block 928 to set, for example, the phase and on-time of the pulses in the PWM signal. On-time and phase control block 928 may adjust the phase and on-time of the PWM signal based on inputs from a phase shifter 926, and a current balancing circuit that includes a current sensing circuit 930, a resistor 932, and an amplifier 934.

Phase shifter 926 may set the phase of the clock for a power phase using the clock signal from central controller 802 and a phase address (or identification) of the power phase determined by a phase address decoder 924. For example, phase address decoder 924 may determine the phase address (or identification) of the power phase based on the value of an external resistor. If the power phase is the first power phase of N power phases, phase shifter 926 may not shift the phase of the clock signal received from central controller 802. If the power phase is a second power phase of the N power phases, phase shifter 926 in the power phase may shift the phase of the clock signal received from central controller 802 by 360/N. If the power phase is a third power phase of the N power phases, phase shifter 926 in the power phase may shift the phase of the clock signal received from central controller 802 by 2×360/N, and so on.

Current sensing circuit 930 of the current balancing circuit may sense the current of the power stage, and amplifier 934 may generate a current balancing signal base on a difference between the sensed current of the power stage and an average current of the N power phases, such as a voltage drop across resistor 932. The current balancing signal may be used by on-time and phase control block 928 to set the widths of the pulses and thus the on-time of the switches in the power stage. For example, if the sensed current of the power stage of a power phase is higher than the average current of the N power phases, the pulse width of the PWM signal generated by the power phase may be reduced to reduce the current supplied by the power phase, thereby balancing the current supplied by the power phases. In some examples, the on-time or the pulse width of the PWM signal may depend on the input voltage of the power converter.

The PWM signal outputted by PWM comparator 920 and modulated by on-time and phase control block 928 may be provided to a driver 936. Driver 936 may generate switch control signals for switching high-side switch 840 and low-side switch 842 as described above with respect to, for example, FIGS. 2 and 3. Current may be supplied from the input voltage VIN through high-side switch 840 to an inductor 850, one or more decoupling capacitors, and the load.

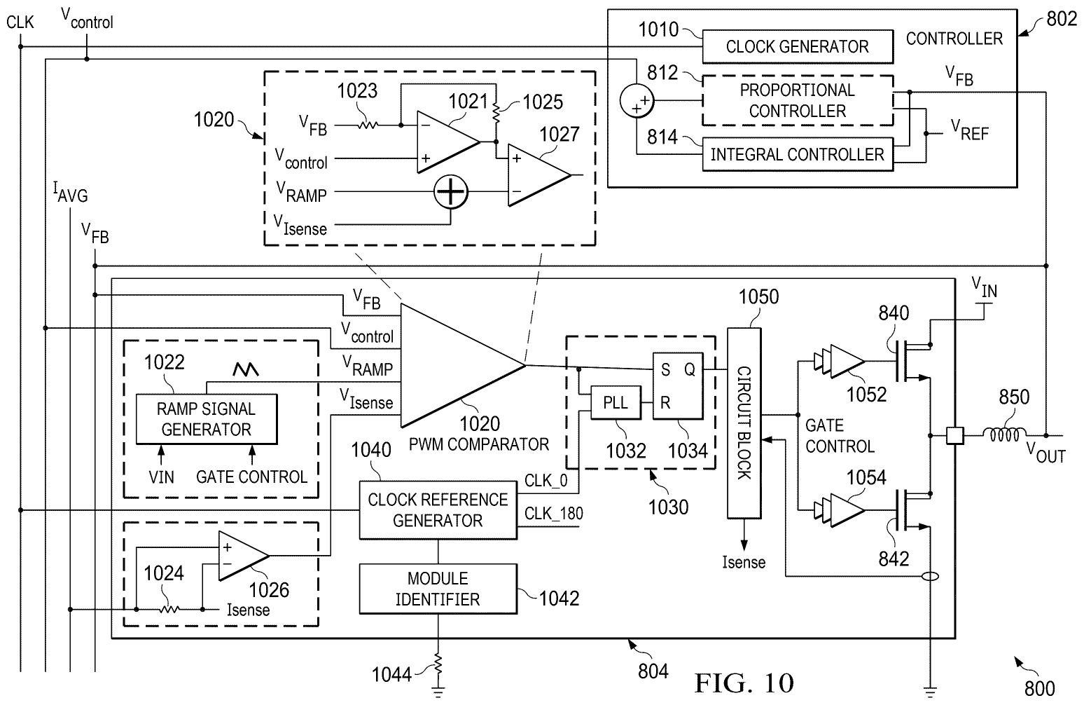

FIG. 10 is a schematic of another example of DCOT multiphase power converter 800. In the illustrated example, central controller 802 may include integral controller 814, optional proportional controller 812, and a clock generator 1010. As described above, integral controller 814 may integrate the difference between the feedback voltage V_{FB} of DCOT multiphase power converter 800 and the reference voltage V_{REF} to generate an integral error signal. The feedback voltage V_{FB} may be equal to or proportional to (e.g., a fraction of) the output voltage V_{OUT}. Optional proportional controller 812 may generate a proportional error signal that is proportional to the difference between the feedback voltage V_{FB} and the reference voltage V_{REF}. Central controller 802 may output the integral error signal or the sum of the integral error signal and the proportional error signal as a control signal V_{control} that may be used by the multiple power phases. Clock generator 1010 may generate a clock signal based on a frequency reference signal (e.g., from a crystal oscillator, a MEMS oscillator, or a ring oscillator). In some examples, clock generator 1010 may be a clock synthesizer that may include a phase-locked loop (PLL). The clock signal may be used to synchronize the power phases and the switching control signals for controlling the switches in the power stages.

Each power phase (e.g., power phase 804) may include a PWM comparator 1020, a ramp signal generator 1022, and an on-time and phase control block 1030. PWM comparator 1020 may generate a PWM signal using the error signal V_{control}, feedback voltage V_{FB}, a ramp signal V_{RAMP} generated by ramp signal generator 1022, and/or a current balancing signal V_{Isense} generated by a current balancing circuit that includes a resistor 1024 and an amplifier 1026. In one example shown in FIG. 10, PWM comparator 1020 may operate in the analog domain and may include a first amplifier 1021 and a comparator 1027. First amplifier 1021 is configurable as a proportional amplifier for a proportional controller. For example, the negative input of first amplifier 1021 may be coupled to the feedback voltage V_{FB} through an input resistor 1023, and a feedback resistor 1025 may be coupled between the negative input of first amplifier 1021 and the output of first amplifier 1021. The positive input of first amplifier 1021 may be coupled to the error signal V_{control}. Therefore, the output of first amplifier 1021 may include a portion that is proportional to a difference between the error signal V_{control} and the feedback voltage V_{FB}. A comparator 1027 may compare the output of first amplifier 1021 with a ramp signal V_{RAMP} to generate a serial of pulses as described above. In other examples, PWM comparator 1020 may operate in digital domain and can include ADCs to convert V_{FB}, V_{control}, V_{RAMP}, and V_{Isense} to digital values, as well as digital logic circuits to perform amplification and comparison operations represented by amplifier 1021 and comparator 1027.

The ramp signal V_{RAMP} may be sawtooth ramp signal generated by ramp signal generator 1022 based on a clock signal and/or a sensed current of the power stage. In some examples, the ramp signal V_{RAMP} may be generated based additionally on the input voltage of DCOT multiphase power converter 800 and/or the gate control signal for controlling the switches in the power stage. When the output of first amplifier 1021 is higher than the ramp signal V_{RAMP}, the output of comparator 1027 may be set to a high level. When the ramp signal V_{RAMP} increases to levels higher than the output of first amplifier 1021, the output of comparator 1027 may be set to a low level. In this way, a PWM signal including series of pulses may be generated at the output of comparator 1027.

In some examples, PWM comparator 1020 may also generate the PWM signal using current balancing signal V_{Isense} generated by the current balancing circuit. Amplifier 1026 of the current balancing circuit may generate current balancing signal V_{Isense} based on a difference between a sensed current of the power stage and an average current of the power phases, such as a voltage drop across resistor 1024. The current balancing signal V_{Isense} may be used to adjust the pulse width and/or density of the pulses generated by comparator 1027. For example, if the sensed current of the power stage of a power phase is higher than the average current of the power phases, the pulse width of the PWM signal generated by PWM comparator 1020 may be reduced to reduce the current supplied by the power phase, thereby balancing the current supplied by the power phases.

On-time and phase control block 1030 may include a phase-locked loop (PLL) 1032 and a latch 1034, and may adjust, for example, the phase and on-time of the pulses in the PWM signal generated by PWM comparator 1020. For example, a module identifier 1042 may determine the address of the power phase in a system based on the value of an external resistor 1044. External resistors 1044 in different power phases may have different values to indicate the different identifiers or addresses of the power phases. In some examples, the addresses of the power phases may be set in other manners, such as using external bit encoders. If a power phase is a first power phase of the N power phases of DCOT multiphase power converter 800, the phase of the output clock generated by a clock reference generator 1040 may not be shifted with respect to the phase of the clock signal received from central controller 802. If a power phase is a second power phase of the N power phases, clock reference generator 1040 in the power phase may shift the phase of the clock signal received from central controller 802 by 360/N. If a power phase is a third power phase of the N power phases, clock reference generator 1040 in the power phase may shift the phase of the clock signal received from central controller 802 by 2×360/N, and so on. The output of latch 1034 may be set by the PWM signal generated by PWM comparator 1020, and may be reset by a signal generated by PLL 1032 based on the clock signal generated by clock reference generator 1040. Therefore, the signal at the output of latch 1034 may be a modulated PWM signal with modulated pulse width and/or pulse density.

The PWM signal outputted by on-time and phase control block 1030 may be provided to drivers 1052 and 1054. Driver 1052 may generate switch control signals for switching high-side switch 840, while driver 1054 may generate switch control signals for switching a low-side switch 842. When high-side switch 840 is turned on, current may be supplied from the input voltage VIN through high-side switch 840 to inductor 850, one or more decoupling capacitors, and the load. By controlling the on-time and switching frequency of high-side switch 840 and low-side switch 842, the output voltage level may be set to a target value or range.

In the illustrated example, the local controller of each power phase may include a circuit block 1050 between on-time and phase control block 1030 and the power stage. Circuit block 1050 may adjust dead time and gate drive, and protect the switches (e.g., MOSFETs). For example, circuit block 1050 may sense the current of the power stage, and may turn off the power stage if the sensed current is above a threshold value. Circuit block 1050 may also provide the sensed current of the power stage to the current balancing circuit.

In some examples, the load controller in each power phase in DCOT multiphase power converter 800 may be a digital controller, such as a CPU, a microcontroller, a digital signal processor, or other digital logic. The digital controller may generate the PWM signal based on a digitized error signal and a digitized feedback voltage level.

The distributed control scheme described above may be implemented using other control schemes, such as the voltage mode or current mode constant-frequency control scheme. In all these control schemes, the proportional controller and the PWM generator can be implemented locally at the power phases to reduce the AC loop delay. In one example, the power converter can be modified so that the PLL (or a clock signal from a clock generator) may control the Set(S) input of latch 1034, and the local PWM comparator 1020 may control the Reset (R) input of latch 1034, to make the power converter a constant-frequency power converter as described above with respect to FIG. 2. In some examples, both the on time and the switching frequency may be dynamically adjusted in each local controller, and the power converter may be a distributed adaptive on-time (DAOT) multiphase power converter.

Compared with CCOT multiphase power converters, the DCOT multiphase power converters (and DAOT multiphase power converters) disclosed herein may have much lower loop delay and latency, and much shorter delay between the PWM comparator and the power stage in the same power phase. Therefore, the DCOT multiphase power converters can have short response time for load transients, can support higher frequency operation, and can support low or high duty cycles (and short on time or short off time) because of the low latency. Due to the shorter control loop, the output impedance of the DCOT multiphase power converter can remain low from DC to a higher frequency, and thus the capacitance of the decoupling capacitors and/or the number of decoupling capacitors at the output of the capacitor can be reduced.

As described above, in CCOT multiphase power converters, a centralized PWM comparator is used to generate the switching control signals for multiple (e.g., N) power phases, and thus the centralized PWM comparator would operate at a clock frequency that is N times of the switching frequency of each power stage. Therefore, CCOT multiphase power converters may have scalability issue, and may not be able to support a large number of power phases and a high load current at least due to the operating frequency limitation. In contrast, in the DCOT (or DAOT) multiphase power converters disclosed herein, the PWM comparator in each local controller generates switching control signals for the power stage of one power phase, and thus the PWM comparator can operate at the switching frequency of the power stage, regardless of the number of power phases in the multiphase power converters. Therefore, the number of power phases in a DCOT (or DAOT) multiphase power converter may not be limited by the operating frequency and can be large.

Furthermore, in CCOT multiphase power converters, the respective PWM signals are sent from the central controller to each power phase. When the number of power phases is large, a large number of electrical interconnects (e.g., pins and traces) may be used to route the PWM signals. Therefore, the routing overhead may be high and the paths of at least some electrical interconnects may be long, which may cause a long loop delay and response time. In contrast, in the DCOT (or DAOT) multiphase power converters disclosed herein, the same error signal (or DC or low-frequency loop control signal), clock signal, and/or average current signal are shared by all power phases and thus can be more easily routed from the central controller to all power phases. Therefore, the number of pins on the central controller and the routing overhead on a PCB can be significantly reduced, in particular, when the number of power phases is large. As such, the DCOT (or DAOT) multiphase power converters disclosed herein can have more power phases to support higher load current with low routing overhead.

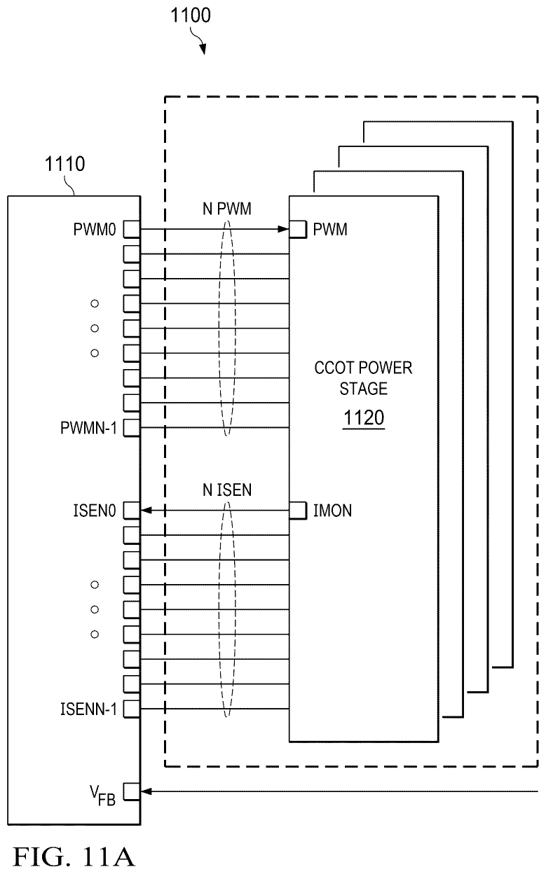

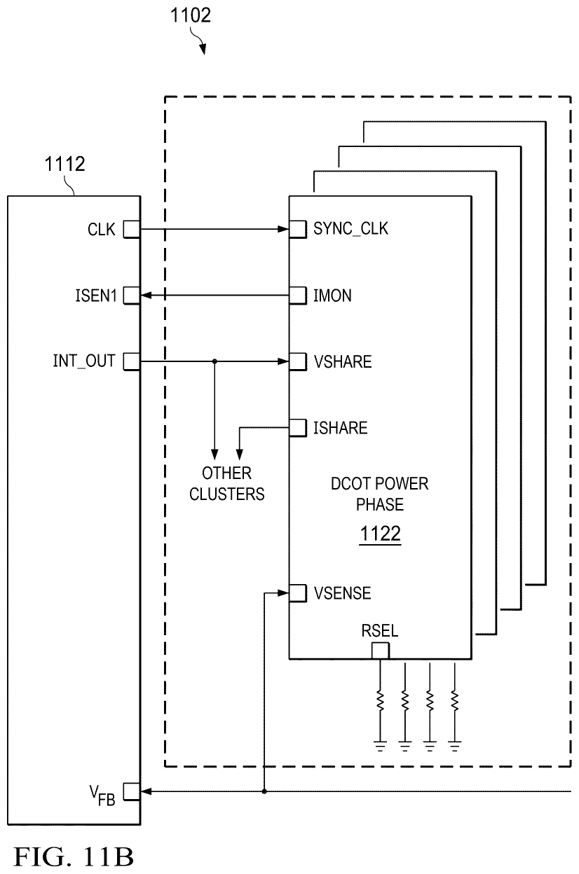

FIG. 11A is block diagram of an example of a system including a CCOT multiphase power converter 1100. CCOT multiphase power converter 1100 may include a central controller 1110 and a plurality of power phases 1120. Central controller 1110 may receive a feedback voltage V_{FB} (e.g., the output voltage of the power converter) and a sensed current signal ISENSE from each power phase of the plurality of power phases, and may send a respective PWM signal to each power phase 1120. Therefore, if the plurality of power phases 1120 includes N power phases, the total number of interconnects between central controller 1110 and the N power phases may be 2N+1.

FIG. 11B is block diagram of an example of a system including a DCOT multiphase power converter 1102. DCOT multiphase power converter 1102 may include a central controller 1112 and a plurality of power phases 1122. Central controller 1110 may receive a feedback voltage V_{FB} (e.g., the output voltage of the power converter) and a sensed current signal ISENSE from each power phase of the plurality of power phases 1122, and may send a shared clock signal CLK and a shared integrated error signal INT_OUT generated by an integral controller to the plurality of power phases. Therefore, if the plurality of power phases 1122 includes N power phases, the total number of interconnects between central controller 1112 and the N power phases 1122 may be 3+N, which can be smaller than 2N+1 when N is large.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of at least a part of Y and any number of other factors. If an action X is “based on” Y, then the action X may be based at least in part on at least a part of Y.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “on” or “enabled” means that the conduction channel of the FET is present and drain current Ip (or drain-to-source current Ips) may flow through the FET. References herein to a FET being “off” or “disabled” means that the conduction channel is not present so drain current does not flow through the FET. An “off” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description.

In this description, unless otherwise stated, “about,” “approximately” or “substantially” preceding a parameter means being within +/−10 percent of that parameter or, if the parameter is zero, a reasonable range of values around zero.

Terms “and” and “or,” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC, AA, ABC, AAB, ACC, AABBCCC, or the like.

Although various examples have been described in detail, it should be understood that various changes, substitutions, and alterations can be made therein without departing from the scope defined by the appended claims. The devices, structures, materials, and processes discussed above are examples. Various examples may omit, substitute, or add various procedures or components as appropriate. Also, features described with respect to certain examples may be combined in various other examples. Different aspects and elements of the examples may be combined in a similar manner. Also, technology evolves and, thus, many of the elements are examples that do not limit the scope of the disclosure to those specific examples.

Specific details are given in the description on order to provide a thorough understanding of the examples. However, examples may be practiced without these specific details. For example, well-known circuits, processes, systems, structures, and techniques may have been shown without unnecessary detail in order to avoid obscuring the examples. This description provides examples only, and is not intended to limit the scope, applicability, or configuration of the invention. Rather, the preceding description of the examples will provide those skilled in the art with an enabling description for implementing various examples. Various changes may be made in the function and arrangement of elements without departing from the spirit and scope of the present disclosure. Modifications are possible in the described examples, and other examples are possible, within the scope of the claims.

What is claimed is:

1. An apparatus comprising:
an integrated circuit comprising:
a power stage having a control input and a voltage output terminal; and
a controller having a feedback voltage input, an error signal input, and a control output, the control output coupled to the control input of the power stage, the controller configurable to provide a modulated signal at the control output responsive to a first signal at the feedback voltage input and a second signal at the error signal input.

2. The apparatus of claim 1, wherein the controller is configurable to generate the modulated signal based on at least a difference between the first signal and the second signal.

3. The apparatus of claim 1, wherein the second signal includes an integral of a difference between the first signal and a reference signal.

4. The apparatus of claim 1, wherein:
the controller includes a ramp signal generator configurable to generate a ramp signal; and
the controller is configurable to provide the modulated signal based on at least the ramp signal.

5. The apparatus of claim 4, wherein:
the controller includes a current sensing circuit configurable to sense a current of the power stage; and
the controller is configurable to provide the modulated signal based on at least the sensed current of the power stage.

6. The apparatus of claim 5, wherein:
the controller includes a current input; and
the controller is configurable to provide the modulated signal based on at least a difference between the sensed current of the power stage and a current signal received at the current input.

7. The apparatus of claim 1, wherein:
the modulated signal includes a modulated pulse signal; and
the controller is configurable to set at least one of a pulse width of the modulated pulse signal or a pulse density of the modulated pulse signal.

8. The apparatus of claim 7, wherein:
the integrated circuit includes a chip identification circuit configurable to determine an identifier of the integrated circuit in the apparatus; and
the controller is configurable to set a phase of the modulated pulse signal based on the identifier of the integrated circuit.

9. The apparatus of claim 1, wherein the controller includes:
a proportional amplifier including a first input, a second input, and a first output, the first input coupled to the feedback voltage input, the second input coupled to the error signal input;
a ramp generator including a second output and configurable to output a ramp signal at the second output;
a comparator including a third input, a fourth input, and a third output, the third input coupled to the first output, the fourth input coupled to the second output; and
an on-time modulation circuit including a fifth input and a fourth output, the fifth input coupled to the third output, the fourth output coupled to the control output.

10. The apparatus of claim 9, wherein:
the controller further includes a current sensing circuit configurable to sense a current of the power stage and output a current balancing signal at a fifth output based on the sensed current; and
the fourth input is coupled to both the second output and the fifth output.

11. The apparatus of claim 1, wherein the power stage includes a half bridge circuit.

12. An apparatus comprising:
a first integrated circuit having a first feedback voltage input and an error signal output, the first feedback voltage input coupled to a power rail; and
a second integrated circuit having a second feedback voltage input, a first error signal input, and a first power output, the second feedback voltage input coupled to the power rail, the first error signal input coupled to the error signal output, and the first power output coupled to the power rail; and
a third integrated circuit having a third feedback voltage input, a second error signal input, and a second power output, the third feedback voltage input coupled to the power rail, the second error signal input coupled to the error signal output, and the second power output coupled to the power rail.

13. The apparatus of claim 12, further comprising a first inductor and a second inductor, wherein:
the first power output is coupled to the power rail through the first inductor; and
the second power output is coupled to the power rail through the second inductor.

14. The apparatus of claim 12, wherein the first integrated circuit includes an integral controller configurable to integrate a difference between a reference voltage signal and a first signal at the first feedback voltage input to generate an integral error signal.

15. The apparatus of claim 14, wherein:
the first integrated circuit further includes a proportional controller configurable to generate a proportional error signal based on the first signal at the first feedback voltage input and the reference voltage signal; and
the first integrated circuit is configurable to output an error control signal at the error signal output, the error control signal including a combination of the integral error signal and the proportional error signal.

16. The apparatus of claim 12, wherein each of the second integrated circuit and the third integrated circuit includes:
a power stage; and
a pulse-width modulation (PWM) signal generator configurable to generate a modulated pulse signal to control the power stage.

17. The apparatus of claim 16, wherein the PWM signal generator of the second integrated circuit is configurable to adjust a pulse width or pulse density of the modulated pulse signal based on:
a first signal at the second feedback voltage input;
a second signal at the first error signal input; and
at least one of a ramp signal or a current of the power stage.

18. The apparatus of claim 16, wherein the second integrated circuit includes:
a chip identification circuit configurable to determine an identifier of the second integrated circuit; and
a phase controller configurable to adjust a phase of the modulated pulse signal based on the identifier of the second integrated circuit.

19. The apparatus of claim 12, further comprising a circuit coupled to the power rail, the circuit including at least one of a central processing unit, a graphic processing unit, a neural processing unit, a tensor processing unit, an application-specific integrated circuit, or a field-programmable gate array.

20. An apparatus comprising:
an integral controller having a first feedback voltage input, a reference voltage input, and a first control output;
a first proportional controller having a second feedback voltage input, a first control input, and a second control output, the first control input coupled to the first control output;
a second proportional controller having a third feedback voltage input, a second control input, and a third control output, the second control input coupled to the first control output;
a first power stage having a first power input, a first power stage control input, and a first power output, the first power stage control input coupled to the second control output; and
a second power stage having a second power input, a second power stage control input, and a second power output, the second power stage control input coupled to the third control output.

21. The apparatus of claim 20, further comprising:
a first inductor coupled between the first power output and a power rail; and
a second inductor coupled between the second power output and the power rail,
wherein the second feedback voltage input and the third feedback voltage input are coupled to the power rail.

22. The apparatus of claim 21, further comprising a load coupled to the power rail, the load including at least one of a central processing unit, a graphic processing unit, a neural processing unit, a tensor processing unit, an application-specific integrated circuit, or a field-programmable gate array.

23. The apparatus of claim 21, wherein:
the first proportional controller is configurable to adjust a first switching frequency of a first switching signal at the second control output based on at least signals at the second feedback voltage input and the first control input; and
the second proportional controller is configurable to adjust a second switching frequency of a second switching signal at the third control output based on at least signals at the third feedback voltage input and the second control input.

24. The apparatus of claim 20, wherein:
the first proportional controller is configurable to adjust a first pulse width of a first switching signal at the second control output based on at least signals at the second feedback voltage input and the first control input; and
the second proportional controller is configurable to adjust a second pulse width of a second switching signal at the third control output based on at least signals at the third feedback voltage input and the second control input.

25. The apparatus of claim 20, wherein the first power stage comprises:
a first switch including a first terminal, a second terminal, and a first control terminal, the first terminal coupled to the first power input, the second terminal coupled to the first power output, and the first control terminal coupled to the second control output; and
a second switch including a third terminal, a fourth terminal, and a second control terminal, the third terminal coupled to the first power output, the fourth terminal coupled to ground, and the second control terminal coupled to the second control output.

26. The apparatus of claim 20, wherein the first proportional controller and the first power stage are on a same semiconductor die.

27. The apparatus of claim 20, wherein the first proportional controller is configurable to set an on-time or switching frequency of a modulated signal at the second control output based on:
a first signal at the second feedback voltage input;
a second signal at the first control input; and
at least a ramp signal or a current of the first power stage.

28. The apparatus of claim 27, wherein the first proportional controller includes:
a chip identification circuit configurable to determine an identifier associated with the first proportional controller; and
a phase controller configurable to set a phase of the modulated signal based on the identifier.
